(19) United States
(12) Patent Application Publication
(10) Pub. No.: US 2018/0293086 A1
(43) Pub. Date: Oct. 11, 2018

(54) CROSS-APPLICATION CONTENT INJECTION

(71) Applicant: Microsoft Technology Licensing, LLC, Redmond, WA (US)

(72) Inventors: Thomas M. LAIRD-McCONNELL, Kirkland, WA (US); David CLAUX, Redmond, WA (US); Matthew G. HIDINGER, Seattle, WA (US)

(21) Appl. No.: 15/630,898

(22) Filed: Jun. 22, 2017

Related U.S. Application Data
(60) Provisional application No. 62/503,810, filed on May 9, 2017.
(60) Provisional application No. 62/482,616, filed on Apr. 6, 2017.

(51) Int. Cl. G06F 9/445; G06F 9/455; G06F 17/30; H04L 29/08; H04L 29/06

(52) U.S. Cl. CPC G06F 9/44526; G06F 9/45529; H04L 67/42; H04L 67/02; G06F 17/30899

(57) ABSTRACT

A facility for injecting content into host applications is described. The facility receives from an originating program a content payload specifying (1) two or more elements of content, and (2) a relative significance among at least two of the elements of content. The facility also receives from the originating program information identifying a host program in the context of which the content of the received content payload is to be rendered. The facility determines a rendering strategy based at least in part on the identity of the host program. The facility uses the determined rendering strategy to generate a rendered version of the content of the received content payload, and causes the generated rendered version of the content of the received content payload to be displayed in the context of the identified host program.

### CROSS-REFERENCE TO RELATED APPLICATIONS

This application claims the benefit of U.S. Provisional Patent Application No. 62/482,616, filed Apr. 6, 2017, and U.S. Provisional Patent Application No. 62/503,810, filed May 9, 2017.

### BACKGROUND

In many cases, it is desirable for a first application to be able to cause certain content to be displayed in the context of a second application. For example, a development tool application may wish to cause information about a task created in the development tool to be displayed in the context of an email client application, or a travel application may wish to cause status information about a flight tracked by the travel application to be displayed in the context of a calendar application. This is sometimes referred to as “injecting” the content; the application injecting the content is sometimes referred to as the “originating application,” while the application into which the content is injected is sometimes referred to as the “host application.”

In a first “forms” approach to content injection, in its role as a host application, a particular application defines one or more types of forms that originating applications can use to display content. For each form type, a list of fields is established for which an injecting application can specify values. For example, an email client application can define a task form for use by originating applications that includes 6 fields common to most tasks. An originating application can use the task form by explicitly selecting it, and specifying values for some or all of its six fields.

In a second “fully specified” approach to content injection, an originating application can fully define the rendering of the injected content, such as by generating an HTML version of the content, or a bitmap of the content.

### SUMMARY

This summary is provided to introduce a selection of concepts in a simplified form that are further described below in the Detailed Description. This summary is not intended to identify key factors or essential features of the claimed subject matter, nor is it intended to be used to limit the scope of the claimed subject matter.

A facility for injecting content into host applications is described. The facility receives from an originating program a content payload specifying (1) two or more elements of content, and (2) a relative significance among at least two of the elements of content. The facility also receives from the originating program information identifying a host program in the context of which the content of the received content payload is to be rendered. The facility determines a rendering strategy based at least in part on the identity of the host program. The facility uses the determined rendering strategy to generate a rendered version of the content of the received content payload, and causes the generated rendered version of the content of the received content payload to be displayed in the context of the identified host program.

### BRIEF DESCRIPTION OF THE DRAWINGS

FIG. 1 is a block diagram showing some of the components typically incorporated in at least some of the computer systems and other devices on which the facility operates.

FIG. 2 is a data flow diagram showing that the content injection mechanism 220 provided by the facility can be used by any of a large number of originating applications—such as originating applications 211-214—to inject content in a large number of host applications—such as host applications 231-234.

FIG. 3 is a flow diagram showing a process performed by the facility in an originating application in some examples to initiate the process of injecting content into a host application.

FIG. 4 is a flow diagram showing a process performed by the facility in the content injection mechanism in some examples to render the content specified by the content payload in a manner suitable to the host application.

FIG. 5 is a flow diagram showing a process performed by the facility in a host application in some examples to process rendered content provided by the content injection mechanism.

FIG. 6 is a state diagram showing a state of the facility at a particular point in time, after the content injection mechanism has been installed, and after three host applications have been registered with the content injection mechanism.

FIG. 7 is a table diagram showing sample contents of a rendering strategy table used by the facility in some examples to determine how to render a particular content payload for a particular host application on a particular platform.

FIG. 8 is a state diagram showing a first rendering scenario.

FIG. 9 is a display diagram showing how the content payload is rendered in the first scenario.

FIG. 10 is a state diagram showing a second rendering scenario

FIG. 11 is a display diagram showing how the content payload is rendered in the second scenario.

FIG. 12 is a state diagram showing a third rendering scenario.

FIG. 13 is a display diagram showing the content rendered in scenario three for the second host application.

FIG. 14 is a state diagram showing a fourth rendering scenario

FIG. 15 is a state diagram showing a fifth rendering scenario.

### DETAILED DESCRIPTION

The inventors have recognized significant disadvantages attending the conventional approaches to content injection discussed above. They have recognized that the forms conventional approach to content injection provides very little control to the originating application, in terms of both substance and form. In terms of substance, if a form has not been defined by the intended host application that includes all the fields that an originating application wishes to specify, the originating application must choose between injecting no content and selecting a form defined by the host application that allows the originating application to specify a proper subset of the desired set of fields, in both cases preventing the originating application from providing certain information that would be useful to the user of the host application. In terms of form, the forms approach provides the originating application with little or no control over how the elements of the form are rendered, including such factors as spatial arrangement of the elements, relative size of the elements, relative importance of the elements, etc. This limits the ability of the originating application to arrange the injected content in a way that is easily understood and digested by the user of the host application.

The inventors have further realized that the forms conventional approach to content injection requires a very high level of collaboration between the developers of different applications. Each application that can serve as an originating application must be developed and updated in a way that is attentive to all of the forms made available by any other application into which it is desirable to inject content. Similarly, each application that can serve as a host application must be developed and updated in a way that is attentive to the kinds of forms favored by any other application from which is desirable to be able to receive injected content.

The inventors have also identified significant disadvantages of the fully specified conventional approach to content injection. First, giving the originating application full control over the appearance of the injected content has the effect of depriving the host application of any control over the appearance of injected content. This prevents the host application from coordinating the appearance of the injected content with the visual style of the host application, often making the injected content visually discordant with the appearance of the host application. Also, in many cases, permitting the originating application to fully specify the injected content provides to the originating application too great a measure of programmatic control over the host application, in many cases permitting uncontrolled, unmonitored access to host application data structures and other state, arbitrary Internet locations, etc.

In response to recognizing the foregoing disadvantages, the inventors have conceived and reduced to practice an improved software and/or hardware facility for cross-application content injection (“the facility”). In some examples, the facility allows the originating application to specify content of a wide variety of types, as well as specifying a significant level of organizational information among the different elements of such content. Also, the facility allows the host application a significant degree of control over the visual style with which the elements of the injected content are displayed. While the description below generally refers to the injected content being displayed in the context of the host application, those skilled in the art will appreciate that, in various examples, the facility causes the injected content to be rendered in a variety of other ways, including being outputted as synthesized and/or composited speech, rendered in a variety of other audio forms, etc.

In some examples, the originating application can define the injected content in a manner that is indifferent to the identity of the host application, and/or to the platform on which the host application is executing on behalf of the user. (The “platform” refers to the output presentation mechanism being used by the instance of the host application being used by the targeted user, generally the operating system on which this instance of the host application is executing. Where this host application instance is executing on a server and communicating its output to the user's computer system via a protocol such as HTML, the host application instance is sometimes referred to as executing on a platform corresponding to this output protocol.) In some examples, the facility provides a set of standard renderers—one per supported platform—that can be used to render injected content on behalf of any host application. In some examples, a host application into which content is to be injected provides a host configuration resource that specifies visual style information—that is coordinated with the host application's native visual style—for application to the injected content by the facility's standard renderer for the appropriate platform. When using the facility's standard renderers (also called “host configuration controlled renderers”), in some examples the host application can apply a “style cleanup” resource to the rendered version of the injected content produced by the shared renderer to further adjust visual style information of the rendered version of the injected content to better coordinate with the visual style of the host application. In some examples, a host application is also free to provide its own custom renderer for any platform.

In some cases, the content generated for injection by the originating application is described as being provided in a “content payload” data structure. In some examples, the originating application can include in or with the content payload logic for determining whether to include certain information among the injected content, and/or determining how to organize elements of the injected content. In some examples, the originating application can include in or with the content payload information electing a particular rendering strategy among multiple rendering strategies made available by the host application. For example, a host application may make available two rendering strategies each corresponding to a different host configuration resource provided by the host application.

In some examples, the originating application can include in or with the content payload information for maintaining the integrity of the contents of the content payload over time. For example, in some examples, the facility enables the originating application to specify a time at which the currency of the content payload information will expire, and after which the injected content should no longer be displayed by the host application. In some examples, the facility enables the originating application to further specify a mechanism—such as a URL—usable by the host application and/or the content injection mechanism to retrieve an updated version of the injected content, such as at the time the injected content expires, or at a later time at which the host application is prepared to display the injected content.

By performing some or all of the ways described above, the facility provides a universal mechanism for originating applications to provide a wide variety of information for injection and make recommendations about how it is to be organized for display, and for host applications to coordinate the visual style of the injected content with their own native visual style. The facility further permits an application to do this with few or no dependencies on the identities of the other applications with which it will operate as an originating and/or host application. Also, to a great degree, an application can operate as an originating and special host application without regard for the platform on which the injected content will be displayed.

Also, by performing in some or all of the ways described, the facility meaningfully reduces the hardware resources needed to generate, route, render, and present injected content, including, for example: reducing the amount of storage space needed to store related information; and reducing the number of processing cycles needed to perform these processes. This allows programs making use of the facility to execute on computer systems that have less storage and processing capacity, occupy less physical space, consume less energy, produce less heat, and are less expensive to acquire and operate. Also, such a computer system can perform the content injection process with less latency, producing a better user experience and allowing users to do a particular amount of work in less time.

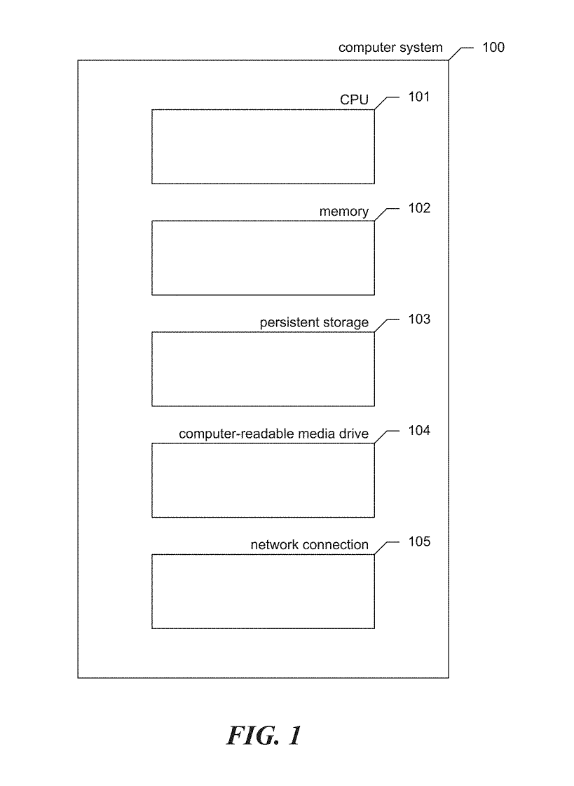

FIG. 1 is a block diagram showing some of the components typically incorporated in at least some of the computer systems and other devices on which the facility operates. In various examples, these computer systems and other devices 100 can include server computer systems, desktop computer systems, laptop computer systems, netbooks, mobile phones, personal digital assistants, televisions, cameras, automobile computers, electronic media players, etc. In various examples, the computer systems and devices include zero or more of each of the following: a central processing unit (“CPU”) 101 for executing computer programs; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

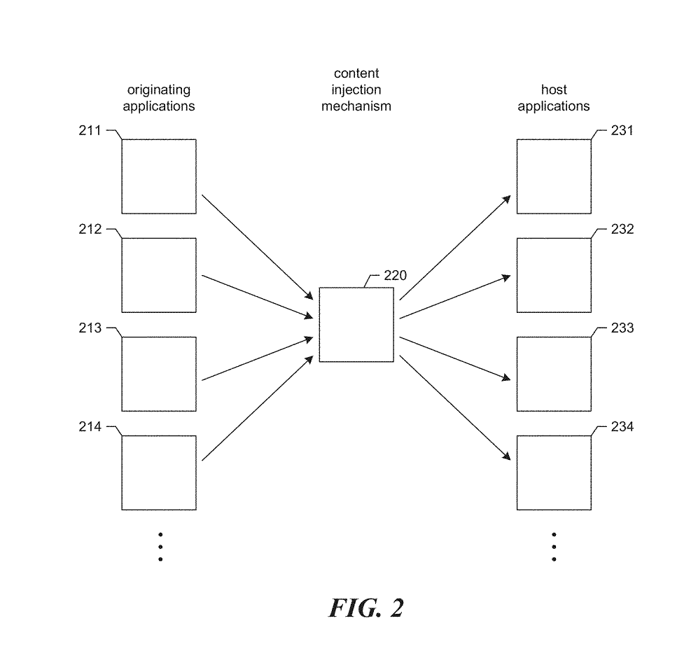

FIG. 2 is a data flow diagram showing that the content injection mechanism 220 provided by the facility can be used by any of a large number of originating applications—such as originating applications 211-214—to inject content in a large number of host applications-such as host applications 231-234. Those skilled in the art will appreciate that a single application may be both an originating application—injecting content into other applications—and a host application—having content injected into it by other applications.

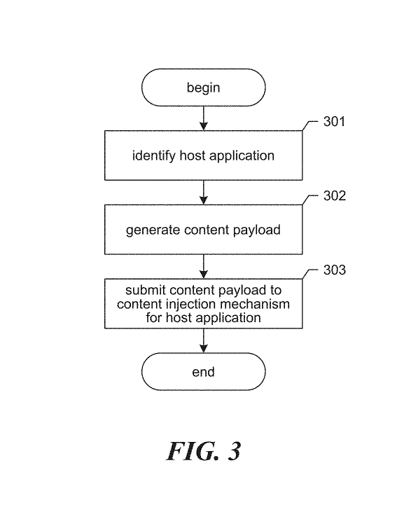

FIG. 3 is a flow diagram showing a process performed by the facility in an originating application in some examples to initiate the process of injecting content into a host application. At 301, the facility identifies a host application in the context of which the injected content will be presented. At 302, the facility generates a content payload specifying the content to be injected, and relative relationship information among some or all of these content elements. At 303, the facility submits the content payload generated at 302 to the content injection mechanism provided by the facility for presentation in the context of the host application identified at 301. After 303, this process concludes.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

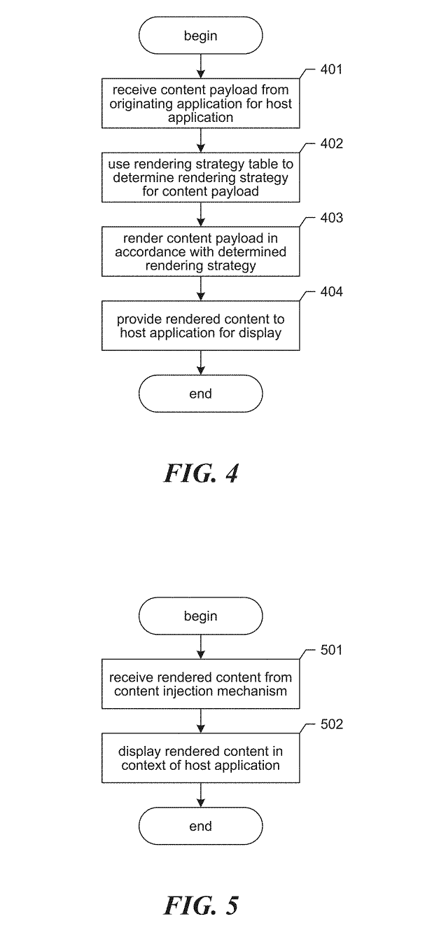

FIG. 4 is a flow diagram showing a process performed by the facility in the content injection mechanism in some examples to render the content specified by the content payload in a manner suitable to the host application. At 401, the facility receives a content payload from an originating application for presentation in the context of a particular host application. At 402, the facility uses a rendering strategy table to determine a rendering strategy to use to render the content payload received at 401. At 403, the facility renders the content payload received at 401 in accordance with the rendering strategy determined at 402. At 404, the facility provides the rendered content obtained at 403 to the host application for display (or other presentation). After 404, these steps conclude.

FIG. 5 is a flow diagram showing a process performed by the facility in a host application in some examples to process rendered content provided by the content injection mechanism. At 501, the facility receives rendered content from the content injection mechanism. At 502, the facility displays—or otherwise presents—the rendered content received at 501 in the context of the host application. As one example, in some cases the host application displays the rendered content within an application window displayed by the host application. After 502, this processes concludes.

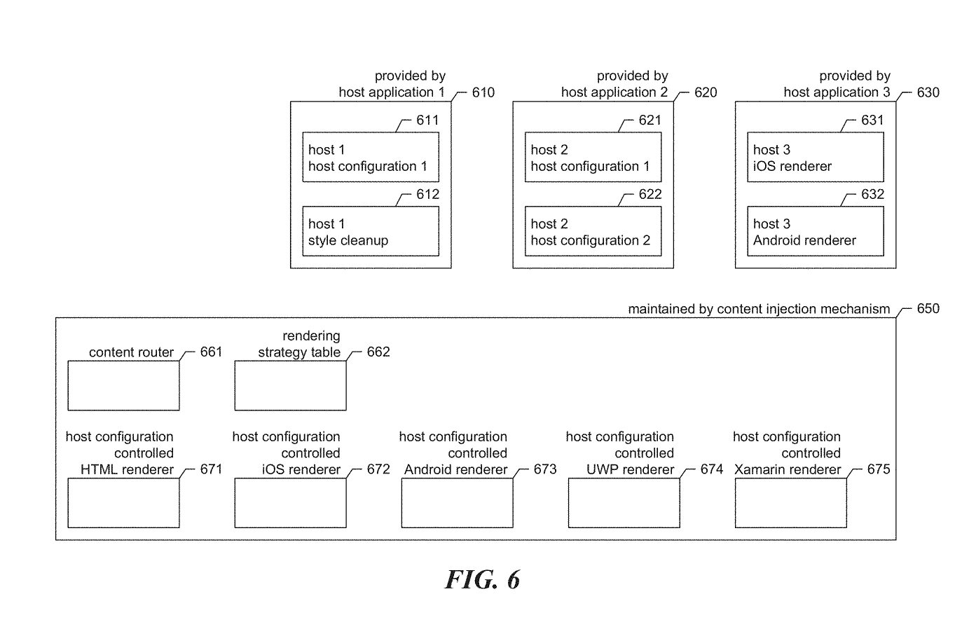

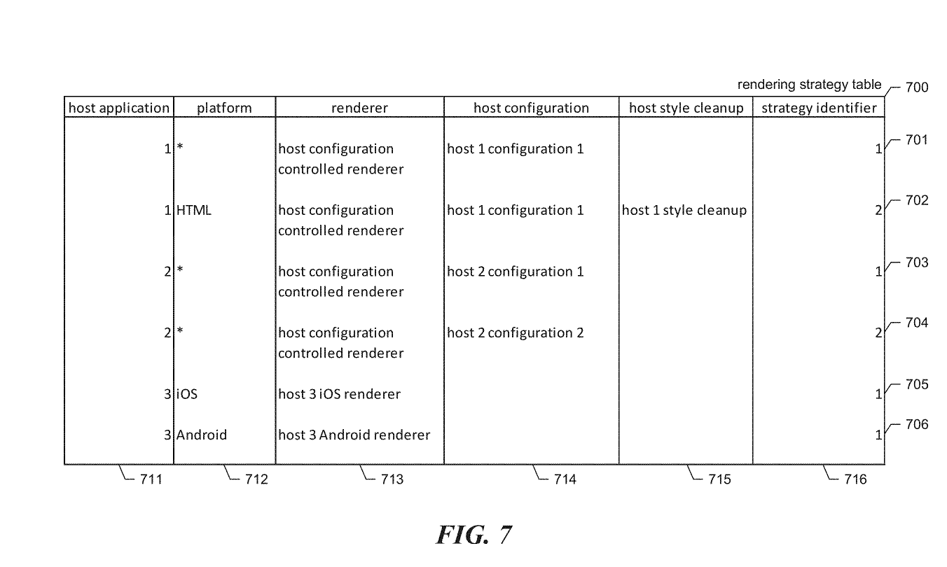

FIG. 6 is a state diagram showing a state of the facility at a particular point in time, after the content injection mechanism has been installed, and after three host applications have been registered with the content injection mechanism. Among resources 650 maintained by the content injection mechanism are content router 661, rendering strategy table 662, and standard renderers for a variety of platforms: a standard renderer 671 for the HTML platform; a standard renderer 672 for the iOS platform; a standard renderer 673 for the Android platform; a standard renderer 674 for the UWP platform; and a standard renderer 675 for the Xamarin platform. In some examples (not shown), to limit the storage space consumed by the content injection mechanism installation, shared renderers for certain platforms not available in a particular computing system (such as operating systems not installed on this computing system) are omitted from the content injection mechanism installation on that computing system. The content router receives content payloads from the originating applications; selection applies a renderer to render each payload, and, in some cases, a style cleanup resource to apply to the rendered content; and forwards the rendered content to the appropriate host application. The facility uses the rendering strategy table, discussed further below in connection with FIG. 7, to select, for each content payload received for a host application, an appropriate “rendering strategy,” which specifies the renderer to use, the host configuration resource to use (if any), and the style cleanup resource to use (if any).

Among resources 610 provided by a first host application are a host configuration 611 for the first host application, and a style cleanup resource 612 for the first host application. Among the resources 620 provided by the second host application are a first host configuration 621 for the second host application, and a second host configuration resource 623 for the second host application. Among the resources 630 provided by the third host application are a custom iOS renderer 631 for the third host application, and a custom Android renderer 632 for the third host application.

Extending the example shown in FIG. 6, FIG. 7 is a table diagram showing sample contents of a rendering strategy table used by the facility in some examples to determine how to render a particular content payload for a particular host application on a particular platform. The rendering strategy table 700 is made up of rows, such as row 701-706, each corresponding to a different rendering strategy. Typically, these rendering strategies reflect information provided by each application as part of its registration or reregistration as a host application into which content can be injected. Each of these rows is divided in the following columns: a host application column 711 containing information identifying a host application to which the rendering strategy to which the row corresponds is for; a platform column indicating one or more platforms to which the rendering strategy applies; a renderer column 713 identifying the renderer that is to be used in the rendering strategy; a host configuration column 714 indicating, for rendering strategies that specify using a shared renderer provided by the facility, the host configuration resource that is to be supplied to the shared renderer, it is invoked as part of the rendering strategy; a host style cleanup column 715 identifying a style cleanup resource to be applied to the rendered content after it is generated, and before it is provided to the host applications; and a strategy identifier column 716 containing information distinguishing among the different rendering strategies that can be applied to the same combination of host application and platform. For example, rows 701 and 702 relate to the first host application. Row 701, having strategy identifier “1,” can apply for any platform, and specifies using the shared renderer for the appropriate platform (e.g., one of standard renderers 671-675) together with the first host configuration resource 611 for the first host application. The strategy specified by row 702, which has strategy identifier “2,” applies only to the HTML platform, and specifies again using the standard renderer 671 for the HTML platform together with the first host configuration resource 611 for the first host application, as well as the style cleanup resource 612 for the first host application. Rows 703 and 704 relate to the second host application. Each is applicable to every platform, and specifies using the shared renderers. The strategy specified by rows 703 provides the second host application's first host configuration resource 621 to the shared renderer for the appropriate platform, while the strategies specified by the row 704 provides the second host configuration 622 for the second host application. Rows 705 and 706 relate to the third host application. The strategy specified by the row 705 is only for the iOS platform, and specifies a custom iOS renderer 631 for the third host application. Similarly, row 706 is only for the Android platform, and specifies the custom Android renderer 632 for the third host application.

While FIG. 7 and each of the table diagrams discussed below show a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; may contain a much larger number of rows than shown, etc.

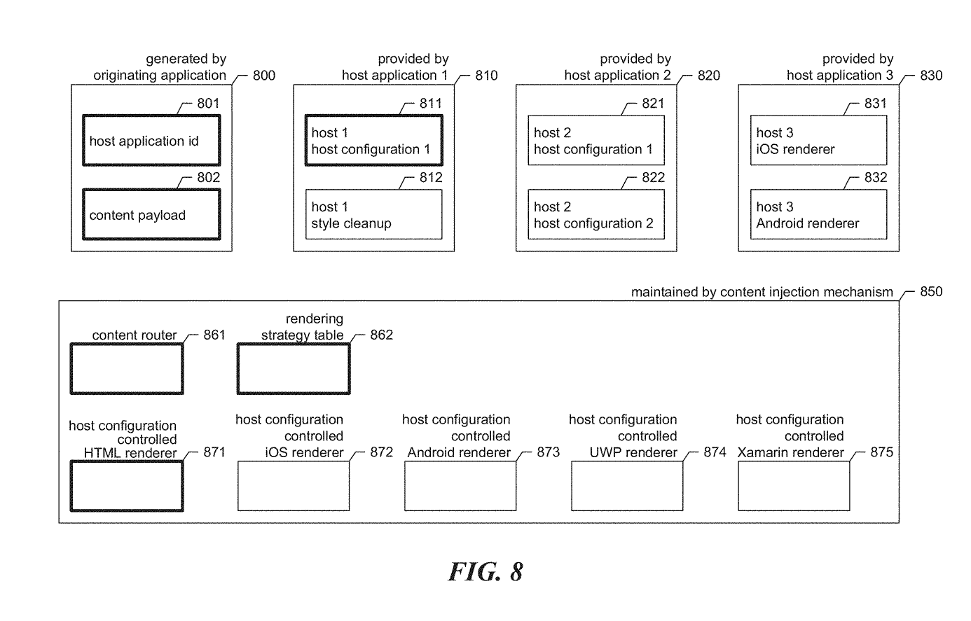

FIG. 8 is a state diagram showing a first rendering scenario. In the first rendering scenario, an originating application has generated a content payload 802, and passed it to the content injection mechanism together with a host application identifier 801 identifying the host application in the context of which the content specified by the payload is to be presented. In particular, in this scenario, the host application ID identifies the first host application, which is executing on the HTML platform—that is, the instance of the first host application being used by the targeted user is executing on a server which is communicating via HTML with the user's computer system. Based upon this information, the facility selects the rendering strategy shown in row 701 of the rendering strategy table for this scenario. Accordingly, the facility invokes the shared renderer for the proper platform—shared renderer 871 for HTML—to render content payload 802, passing this shared renderer the first host configuration resource 811 for the first host application. Unlike the second rendering scenario discussed below, for purposes of the first rendering scenario, the “host 1 style cleanup” entry at the intersection of row 702 with column 715 is treated as absent from the rendering strategy table, and thus the style cleanup resource is not applied in scenario 1.

Table 1 below shows the content payload provided in the first rendering scenario. The same content payload is used for other rendering scenarios discussed above, in some cases adjusted in certain ways as described there.

TABLE 1

| | |
|---|---|
| 1 | { |

| | |
|---|---|
| 2 | “type”: “AdaptiveCard”, |
| 3 | “body”: [ |

| | |
|---|---|
| 4 | { |

| | |
|---|---|
| 5 | “type”: “Container”, |
| 6 | “speak”: “<s>Card created by Miguel Garcia: Publish Adaptive Card |

| | |
|---|---|
| 7 | schema</s>”, |

| | |
|---|---|
| 8 | “items”: [ |

| | |
|---|---|
| 9 | { |

| | |
|---|---|
| 10 | “type”: “TextBlock”, |
| 11 | “text”: “Card created: Publish Adaptive Card schema”, |
| 12 | “weight”: “bolder”, |
| 13 | “size”: “medium” |

| | |
|---|---|
| 14 | }, |
| 15 | { |

| | |
|---|---|
| 16 | “type”: “ColumnSet”, |
| 17 | “columns”: [ |

| | |
|---|---|
| 18 | { |

| | |
|---|---|
| 19 | “type”: “Column”, |
| 20 | “size”: “auto”, |
| 21 | “items”: [ |

| | |
|---|---|
| 22 | { |

| | |
|---|---|
| 23 | “type”: “Image”, |
| 24 | “url”: “http:// |

| | |
|---|---|
| 25 | websites.net/images/Oscar_002.jpg”, |

| | |
|---|---|
| 26 | “size”: “small”, |
| 27 | “style”: “person” |

| | |
|---|---|
| 28 | } |

| | |
|---|---|
| 29 | ] |

| | |
|---|---|
| 30 | }, |
| 31 | { |

| | |
|---|---|
| 32 | “type”: “Column”, |
| 33 | “size”: “stretch”, |
| 34 | “items”: [ |

| | |
|---|---|
| 35 | { |

| | |
|---|---|
| 36 | “type”: “TextBlock”, |
| 37 | “text”: “**Miguel Garcia**”, |
| 38 | “wrap”: true |

| | |
|---|---|
| 39 | }, |
| 40 | { |

| | |
|---|---|
| 41 | “type”: “TextBlock”, |
| 42 | “separation”: “none”, |
| 43 | “text”: “Created |

| | |
|---|---|
| 44 | {{DATE(2017-02-14T06:08:39Z,Long)}} {{TIME(2017-02-14T06:08:39Z)}}”, |

| | |
|---|---|
| 45 | “isSubtle”: true, |
| 46 | “wrap”: true |

| | |
|---|---|
| 47 | } |

| | |
|---|---|
| 48 | ] |

| | |
|---|---|
| 49 | } |

| | |
|---|---|
| 50 | ] |

| | |
|---|---|
| 51 | } |

| | |
|---|---|
| 52 | ] |

| | |
|---|---|
| 53 | }, |
| 54 | { |

| | |
|---|---|
| 55 | “type”: “Container”, |
| 56 | “items”: [ |

| | |
|---|---|
| 57 | { |

| | |
|---|---|
| 58 | “type”: “TextBlock”, |
| 59 | “text”: “Now that we have define the main rules and |

| | |
|---|---|
| 60 | features of the format, we need to produce a schema and publish it to GitHub. The schema |
| 61 | will be the starting point of our reference documentation.”, |

| | |
|---|---|
| 62 | “speak”: “”, |
| 63 | “wrap”: true |

| | |
|---|---|
| 64 | }, |
| 65 | { |

| | |
|---|---|
| 66 | “type”: “FactSet”, |
| 67 | “speak”: “It has been assigned to: David Claux”, |
| 68 | “facts”: [ |

| | |
|---|---|
| 69 | { |

| | |
|---|---|
| 70 | “title”: “Board:”, |
| 71 | “value”: “Adaptive Card” |

| | |
|---|---|
| 72 | }, |
| 73 | { |

| | |
|---|---|
| 74 | “title”: “List:”, |
| 75 | “value”: “Backlog” |

| | |
|---|---|
| 76 | }, |
| 77 | { |

| | |
|---|---|
| 78 | “title”: “Assigned to:”, |
| 79 | “value”: “David Claux” |

| | |
|---|---|
| 80 | }, |
| 81 | { |

| | |
|---|---|
| 82 | “title”: “Due date:”, |
| 83 | “value”: “Not set” |

| | |
|---|---|
| 84 | } |

| | |
|---|---|
| 85 | ] |

| | |
|---|---|
| 86 | } |

| | |
|---|---|
| 87 | ], |
| 88 | “actions”: [ |

| | |
|---|---|
| 89 | { |

| | |
|---|---|
| 90 | “type”: “Action.ShowCard”, |
| 91 | “title”: “Set due date”, |
| 92 | “card”: { |

| | |
|---|---|
| 93 | “type”: “AdaptiveCard”, |
| 94 | “body”: [ |

| | |
|---|---|
| 95 | { |

| | |
|---|---|
| 96 | “type”: “Input.Text”, |
| 97 | “style”: “date”, |
| 98 | “id”: “dueDate”, |
| 99 | “title”: “Select due date” |

| | |
|---|---|
| 100 | } |

| | |
|---|---|
| 101 | ], |
| 102 | “actions”: [ |

| | |
|---|---|
| 103 | { |

| | |
|---|---|
| 104 | “type”: “Action.Http”, |
| 105 | “method”: “POST”, |
| 106 | “title”: “OK”, |
| 107 | “url”: |

| | |
|---|---|
| 108 | “http://xyz.com?dueDate={{dueDate.value}}” |

| | |
|---|---|
| 109 | } |

| | |
|---|---|
| 110 | ] |

| | |
|---|---|
| 111 | } |

| | |
|---|---|
| 112 | }, |
| 113 | { |

| | |
|---|---|
| 114 | “type”: “Action.ShowCard”, |
| 115 | “title”: “Comment”, |
| 116 | “card”: { |

| | |
|---|---|
| 117 | “type”: “AdaptiveCard”, |
| 118 | “body”: [ |

| | |
|---|---|
| 119 | { |

| | |
|---|---|
| 120 | “type”: “Input.Text”, |
| 121 | “id”: “comment”, |
| 122 | “isMultiline”: true, |
| 123 | “title”: “Enter your comment” |

| | |
|---|---|
| 124 | } |

| | |
|---|---|
| 125 | ], |
| 126 | “actions”: [ |

| | |
|---|---|
| 127 | { |

| | |
|---|---|
| 128 | “type”: “Action.Http”, |
| 129 | “method”: “POST”, |
| 130 | “title”: “OK”, |
| 131 | “url”: “http://xyz.com”, |
| 132 | “headers”: { |

| | |
|---|---|
| 133 | “content-type”: |

| | |
|---|---|
| 134 | “application/json” |

| | |
|---|---|
| 135 | }, |
| 136 | “body”: “{ ‘comment’ : |

| | |
|---|---|
| 137 | ‘{{comment.value}}’ }” |

| | |
|---|---|
| 138 | } |

| | |
|---|---|
| 139 | ] |

| | |
|---|---|
| 140 | } |

| | |
|---|---|
| 141 | }, |
| 142 | { |

| | |
|---|---|
| 143 | “type”: “Action.OpenUrl”, |
| 144 | “title”: “View”, |
| 145 | “url”: “http://foo.com” |

| | |
|---|---|
| 146 | } |

| | |
|---|---|
| 147 | ] |

| | |
|---|---|
| 148 | } |

| | |
|---|---|
| 149 | ] |

| | |
|---|---|
| 150 | } |

In some examples, the originating application generates the content payload in accordance with a payload schema defined in connection with the content injection mechanism. Certain details of this sample payload are discussed in greater detail below.

When the content injection mechanism receives the content payload, it identifies the rendering strategy shown in row 802, and invokes the standard HTML renderer to render the payload, passing the renderer the first host configuration resource provided by the first host application shown Table 2 below.

TABLE 2

| | |
|---|---|
| 1 | { |

| | |
|---|---|
| 2 | “actions”: { |

| | |
|---|---|
| 3 | “actionsOrientation”: “vertical”, |
| 4 | “actionAlignment”: “center”, |
| 5 | “backgroundColor”: “#FFC7EDFC”, |
| 6 | “buttonSpacing”: 20, |
| 7 | “maxActions”: 5, |
| 8 | “separation”: { |

| | |
|---|---|
| 9 | “spacing”: 20, |
| 10 | “lineThickness”: 0 |

| | |
|---|---|
| 11 | }, |
| 12 | “showCard”: { |

| | |
|---|---|
| 13 | “actionMode”: “popup”, |
| 14 | “backgroundColor”: “#AEEAEAEA”, |
| 15 | “inlineTopMargin”: 8, |
| 16 | “padding”: { |

| | |
|---|---|
| 17 | “left”: 16, |
| 18 | “top”: 16, |
| 19 | “right”: 16, |
| 20 | “bottom”: 16 |

| | |
|---|---|
| 21 | } |

| | |
|---|---|
| 22 | }, |
| 23 | “stretch”: true, |
| 24 | “padding”: { |

| | |
|---|---|
| 25 | “left”: 12, |
| 26 | “top”: 4, |
| 27 | “right”: 12, |
| 28 | “bottom”: 4 |

| | |
|---|---|
| 29 | }, |
| 30 | “borderColor”: “#FF000000”, |
| 31 | “textColor”: “#FF000000”, |
| 32 | “borderThickness”: 0, |
| 33 | “fontWeight”: 400, |
| 34 | “fontSize”: 16 |

| | |
|---|---|
| 35 | }, |
| 36 | “adaptiveCard”: { |

| | |
|---|---|
| 37 | “padding”: { |

| | |
|---|---|
| 38 | “left”: 20, |
| 39 | “top”: 20, |
| 40 | “right”: 20, |
| 41 | “bottom”: 20 |

| | |
|---|---|
| 42 | }, |
| 43 | “backgroundColor”: “#FFF0F4F8” |

| | |
|---|---|
| 44 | }, |
| 45 | “choiceSet”: { |

| | |
|---|---|
| 46 | “separation”: { |

| | |
|---|---|
| 47 | “spacing”: 10, |
| 48 | “lineThickness”: 0 |

| | |
|---|---|
| 49 | } |

| | |
|---|---|
| 50 | }, |
| 51 | “colors”: { |

| | |
|---|---|
| 52 | “default”: { |

| | |
|---|---|
| 53 | “normal”: “#FF000000”, |
| 54 | “subtle”: “#b2000000” |

| | |
|---|---|
| 55 | }, |
| 56 | “accent”: { |

| | |
|---|---|
| 57 | “normal”: “#2E89FC”, |
| 58 | “subtle”: “#882E89FC” |

| | |
|---|---|
| 59 | }, |
| 60 | “dark”: { |

| | |
|---|---|
| 61 | “normal”: “#333333”, |
| 62 | “subtle”: “#EE333333” |

| | |
|---|---|
| 63 | }, |
| 64 | “light”: { |

| | |
|---|---|
| 65 | “normal”: “#FFFFFF”, |
| 66 | “subtle”: “#88FFFFFF” |

| | |
|---|---|
| 67 | }, |
| 68 | “good”: { |

| | |
|---|---|
| 69 | “normal”: “#00FF00”, |
| 70 | “subtle”: “#DD00FF00” |

| | |
|---|---|
| 71 | }, |
| 72 | “warning”: { |

| | |
|---|---|
| 73 | “normal”: “#FF0000”, |
| 74 | “subtle”: “#DDFF0000” |

| | |
|---|---|
| 75 | }, |
| 76 | “attention”: { |

| | |
|---|---|
| 77 | “normal”: “#FFD800”, |
| 78 | “subtle”: “#DDFFD800” |

| | |
|---|---|
| 79 | } |

| | |
|---|---|
| 80 | }, |
| 81 | “column”: { |

| | |
|---|---|
| 82 | “separation”: { |

| | |
|---|---|
| 83 | “spacing”: 20, |
| 84 | “lineThickness”: 0 |

| | |
|---|---|
| 85 | } |

| | |
|---|---|
| 86 | }, |
| 87 | “columnSet”: { |

| | |
|---|---|
| 88 | “separation”: { |

| | |
|---|---|
| 89 | “spacing”: 20, |
| 90 | “lineThickness”: 0 |

| | |
|---|---|
| 91 | } |

| | |
|---|---|
| 92 | }, |
| 93 | “container”: { |

| | |
|---|---|
| 94 | “normal”: { |

| | |
|---|---|
| 95 | “separation”: { |

| | |
|---|---|
| 96 | “spacing”: 10, |
| 97 | “lineThickness”: 0 |

| | |
|---|---|
| 98 | }, |
| 99 | “backgroundColor”: “#00FFFFFF”, |
| 100 | “padding”: { |

| | |
|---|---|
| 101 | “left”: 0, |
| 102 | “top”: 0, |
| 103 | “right”: 0, |
| 104 | “bottom”: 0 |

| | |
|---|---|
| 105 | }, |
| 106 | “borderColor”: “#00FFFFFF”, |
| 107 | “borderThickness”: { |

| | |
|---|---|
| 108 | “left”: 0, |
| 109 | “top”: 0, |
| 110 | “right”: 0, |
| 111 | “bottom”: 0 |

| | |
|---|---|
| 112 | } |

| | |
|---|---|
| 113 | }, |
| 114 | “emphasis”: { |

| | |
|---|---|
| 115 | “separation”: { |

| | |
|---|---|
| 116 | “spacing”: 10, |
| 117 | “lineThickness”: 0 |

| | |
|---|---|
| 118 | }, |
| 119 | “backgroundColor”: “#EEEEEE”, |
| 120 | “padding”: { |

| | |
|---|---|
| 121 | “left”: 10, |
| 122 | “top”: 10, |
| 123 | “right”: 10, |
| 124 | “bottom”: 10 |

| | |
|---|---|
| 125 | }, |
| 126 | “borderColor”: “#AAAAAA”, |
| 127 | “borderThickness”: { |

| | |
|---|---|
| 128 | “left”: 1, |
| 129 | “top”: 1, |
| 130 | “right”: 1, |
| 131 | “bottom”: 1 |

| | |
|---|---|
| 132 | } |

| | |
|---|---|
| 133 | }, |
| 134 | “separation”: { |

| | |
|---|---|
| 135 | “spacing”: 20, |
| 136 | “lineThickness”: 0 |

| | |
|---|---|
| 137 | } |

| | |
|---|---|
| 138 | }, |
| 139 | “dateInput”: { |

| | |
|---|---|
| 140 | “separation”: { |

| | |
|---|---|
| 141 | “spacing”: 10, |
| 142 | “lineThickness”: 0 |

| | |
|---|---|
| 143 | } |

| | |
|---|---|
| 144 | }, |
| 145 | “imageSizes”: { |

| | |
|---|---|
| 146 | “small”: 40, |
| 147 | “medium”: 80, |
| 148 | “large”: 160 |

| | |
|---|---|
| 149 | }, |
| 150 | “image”: { |

| | |
|---|---|
| 151 | “separation”: { |

| | |
|---|---|
| 152 | “spacing”: 20, |
| 153 | “lineThickness”: 0 |

| | |
|---|---|
| 154 | } |

| | |
|---|---|
| 155 | }, |
| 156 | “imageSet”: { |

| | |
|---|---|
| 157 | “imageSize”: “medium”, |
| 158 | “separation”: { |

| | |
|---|---|
| 159 | “spacing”: 20, |
| 160 | “lineThickness”: 0 |

| | |
|---|---|
| 161 | } |

| | |
|---|---|
| 162 | }, |
| 163 | “factSet”: { |

| | |
|---|---|
| 164 | “title”: { |

| | |
|---|---|
| 165 | “weight”: “bolder”, |
| 166 | “color”: “dark”, |
| 167 | “wrap”: false |

| | |
|---|---|
| 168 | }, |
| 169 | “value”: { |

| | |
|---|---|
| 170 | “color”: “dark”, |
| 171 | “wrap”: false |

| | |
|---|---|
| 172 | }, |
| 173 | “spacing”: 10, |
| 174 | “separation”: { |

| | |
|---|---|
| 175 | “spacing”: 20, |
| 176 | “lineThickness”: 0 |

| | |
|---|---|
| 177 | } |

| | |
|---|---|
| 178 | }, |
| 179 | “fontFamily”: “Segoe UI”, |
| 180 | “fontSizes”: { |

| | |
|---|---|
| 181 | “small”: 12, |
| 182 | “normal”: 14, |
| 183 | “medium”: 17, |
| 184 | “large”: 21, |
| 185 | “extraLarge”: 26 |

| | |
|---|---|
| 186 | }, |
| 187 | “numberInput”: { |

| | |
|---|---|
| 188 | “separation”: { |

| | |
|---|---|
| 189 | “spacing”: 10, |
| 190 | “lineThickness”: 0 |

| | |
|---|---|
| 191 | } |

| | |
|---|---|
| 192 | }, |
| 193 | “strongSeparation”: { |

| | |
|---|---|
| 194 | “spacing”: 40, |
| 195 | “lineThickness”: 1, |
| 196 | “lineColor”: “#EEEEEE” |

| | |
|---|---|
| 197 | }, |
| 198 | “supportsInteractivity”: true, |
| 199 | “textBlock”: { |

| | |
|---|---|
| 200 | “seperations”: { |

| | |
|---|---|
| 201 | “small”: { |

| | |
|---|---|
| 202 | “spacing”: 10, |
| 203 | “lineThickness”: 0 |

| | |
|---|---|
| 204 | }, |
| 205 | “normal”: { |

| | |
|---|---|
| 206 | “spacing”: 10, |
| 207 | “lineThickness”: 0 |

| | |
|---|---|
| 208 | }, |
| 209 | “medium”: { |

| | |
|---|---|
| 210 | “spacing”: 10, |
| 211 | “lineThickness”: 0 |

| | |
|---|---|
| 212 | }, |
| 213 | “large”: { |

| | |
|---|---|
| 214 | “spacing”: 10, |
| 215 | “lineThickness”: 0 |

| | |
|---|---|
| 216 | }, |
| 217 | “extraLarge”: { |

| | |
|---|---|
| 218 | “spacing”: 10, |
| 219 | “lineThickness”: 0 |

| | |
|---|---|
| 220 | } |

| | |
|---|---|
| 221 | } |

| | |
|---|---|
| 222 | }, |
| 223 | “textInput”: { |

| | |
|---|---|
| 224 | “separation”: { |

| | |
|---|---|
| 225 | “spacing”: 10, |
| 226 | “lineThickness”: 0 |

| | |
|---|---|
| 227 | } |

| | |
|---|---|
| 228 | }, |
| 229 | “timeInput”: { |

| | |
|---|---|
| 230 | “separation”: { |

| | |
|---|---|
| 231 | “spacing”: 10, |
| 232 | “lineThickness”: 0 |

| | |
|---|---|
| 233 | } |

| | |
|---|---|
| 234 | }, |
| 235 | “toggleInput”: { |

| | |
|---|---|
| 236 | “separation”: { |

| | |
|---|---|
| 237 | “spacing”: 10, |
| 238 | “lineThickness”: 0 |

| | |
|---|---|
| 239 | } |

| | |
|---|---|
| 240 | } |

| | |
|---|---|
| 241 | } |

Table 3 below shows the HTML generated by the standard HTML renderer using the first host configuration resource for the first host application. This rendered version of the content payload shown in Table 1 will be displayed by the first host application, in the context of the other visual information displayed by the first host application.

TABLE 3

| | |
|---|---|
| 1 | <div class=“ac-container” style=“background-color: rgba(234, 234, 234, 0.682353); padding: |
| 2 | 10px; box-sizing: border-box; width: 350px; text-align: left;”> |

| | |
|---|---|
| 3 | <div class=“ac-container” style=“padding: 0px; box-sizing: border-box; width: 100%; |

| | |
|---|---|
| 4 | text-align: left;”> |

| | |
|---|---|
| 5 | <div style=“font-family: ‘Segoe UI’; font-size: 17px; line-height: 22.61px; color: |

| | |
|---|---|
| 6 | rgb(51, 51, 51); font-weight: 600; white-space: nowrap; box-sizing: border-box; width: |
| 7 | 100%; text-align: left;”> |

| | |
|---|---|
| 8 | <p style=“margin-top: 0px; overflow: hidden; text-overflow: ellipsis; margin- |

| | |
|---|---|
| 9 | bottom: 0px;”>Card created: Publish Adaptive Card schema</p> |

| | |
|---|---|
| 10 | </div> |
| 11 | <div style=“height: 10px;”></div> |
| 12 | <div style=“overflow: hidden; box-sizing: border-box; width: 100%;”> |

| | |
|---|---|
| 13 | <div style=“display: flex;”> |

| | |
|---|---|
| 14 | <div class=“ac-container” style=“padding: 0px; min-width: 0px; flex: 0 1 |

| | |
|---|---|
| 15 | auto;”> |

| | |
|---|---|
| 16 | <div class=“ac-image” style=“display: block; max-width: 40px; box- |

| | |
|---|---|
| 17 | sizing: border-box;”><img |
| 18 | src=“http://connectorsdemo.azurewebsites.net/images/MSC12_Oscar_002.jpg” style=“width: |
| 19 | 100%; border-radius: 50%; background-position: 50% 50%; background-repeat: no- |
| 20 | repeat;”></div> |

| | |
|---|---|
| 21 | </div> |
| 22 | <div style=“width: 10px; flex: 0 0 auto;”></div> |
| 23 | <div class=“ac-container” style=“padding: 0px; min-width: 0px; flex: 1 1 |

| | |
|---|---|
| 24 | auto;”> |

| | |
|---|---|
| 25 | <div style=“font-family: ‘Segoe UI’; font-size: 14px; line-height: |

| | |
|---|---|
| 26 | 18.62px; color: rgb(51, 51, 51); font-weight: 400; word-wrap: break-word; box-sizing: |
| 27 | border-box; width: 100%; text-align: left;”> |

| | |
|---|---|
| 28 | <p style=“margin-top: 0px; margin-bottom: 0px;”><strong>Miguel |

| | |
|---|---|
| 29 | Garcia</strong></p> |

| | |
|---|---|
| 30 | </div> |
| 31 | <div style=“font-family: ‘Segoe UI’; font-size: 14px; line-height: |

| | |
|---|---|
| 32 | 18.62px; color: rgba(51, 51, 51, 0.933333); font-weight: 400; word-wrap: break-word; box- |
| 33 | sizing: border-box; width: 100%; text-align: left;”> |

| | |
|---|---|
| 34 | <p style=“margin-top: 0px; margin-bottom: 0px;”>Created Monday, |

| | |
|---|---|
| 35 | February 13, 2017 10:08:39 PM</p> |

| | |
|---|---|
| 36 | </div> |

| | |
|---|---|
| 37 | </div> |

| | |
|---|---|
| 38 | </div> |

| | |
|---|---|
| 39 | </div> |

| | |
|---|---|
| 40 | </div> |
| 41 | <div style=“height: 10px;”></div> |
| 42 | <div class=“ac-container” style=“padding: 0px; box-sizing: border-box; width: 100%; |

| | |
|---|---|
| 43 | text-align: left;”> |

| | |
|---|---|
| 44 | <div style=“font-family: ‘Segoe UI’; font-size: 14px; line-height: 18.62px; color: |

| | |
|---|---|
| 45 | rgb(51, 51, 51); font-weight: 400; word-wrap: break-word; box-sizing: border-box; width: |
| 46 | 100%; text-align: left;”> |

| | |
|---|---|
| 47 | <p style=“margin-top: 0px; margin-bottom: 0px;”>Now that we have define the |

| | |
|---|---|
| 48 | main rules and features of the format, we need to produce a schema and publish it |

| | |
|---|---|
| 49 | to GitHub. The schema will be the starting point of our reference |

| | |
|---|---|
| 50 | documentation.</p> |

| | |
|---|---|
| 51 | </div> |
| 52 | <div style=“height: 10px;”></div> |
| 53 | <table style=“border-width: 0px; border-spacing: 0px; border-style: none; border- |

| | |
|---|---|
| 54 | collapse: collapse; display: block; overflow: hidden; box-sizing: border-box; text-align: |
| 55 | left;”> |

| | |
|---|---|
| 56 | <tr> |

| | |
|---|---|
| 57 | <td style=“padding: 0px; max-width: 150px; vertical-align: top;”> |

| | |
|---|---|
| 58 | <div style=“font-family: ‘Segoe UI’; font-size: 14px; line-height: |

| | |
|---|---|
| 59 | 18.62px; color: rgb(51, 51, 51); font-weight: 600; word-wrap: break-word; box-sizing: |
| 60 | border-box; text-align: left;”> |

| | |
|---|---|
| 61 | <p style=“margin-top: 0px; margin-bottom: 0px;”>Board:</p> |

| | |
|---|---|
| 62 | </div> |

| | |
|---|---|
| 63 | </td> |
| 64 | <td style=“padding: 0px 0px 0px 10px; vertical-align: top;”> |

| | |
|---|---|
| 65 | <div style=“font-family: ‘Segoe UI’; font-size: 14px; line-height: |

| | |
|---|---|
| 66 | 18.62px; color: rgb(51, 51, 51); font-weight: 400; word-wrap: break-word; box-sizing: |
| 67 | border-box; text-align: left;”> |

| | |
|---|---|
| 68 | <p style=“margin-top: 0px; margin-bottom: 0px;”>Adaptive Card</p> |

| | |
|---|---|
| 69 | </div> |

| | |
|---|---|
| 70 | </td> |

| | |
|---|---|
| 71 | </tr> |
| 72 | <tr style=“margin-top: 10px;”> |

| | |
|---|---|
| 73 | <td style=“padding: 0px; max-width: 150px; vertical-align: top;”> |

| | |
|---|---|
| 74 | <div style=“font-family: ‘Segoe UI’; font-size: 14px; line-height: |

| | |
|---|---|
| 75 | 18.62px; color: rgb(51, 51, 51); font-weight: 600; word-wrap: break-word; box-sizing: |
| 76 | border-box; text-align: left;”> |

| | |
|---|---|
| 77 | <p style=“margin-top: 0px; margin-bottom: 0px;”>List:</p> |

| | |
|---|---|
| 78 | </div> |

| | |
|---|---|
| 79 | </td> |
| 80 | <td style=“padding: 0px 0px 0px 10px; vertical-align: top;”> |

| | |
|---|---|
| 81 | <div style=“font-family: ‘Segoe UI’; font-size: 14px; line-height: |

| | |
|---|---|
| 82 | 18.62px; color: rgb(51, 51, 51); font-weight: 400; word-wrap: break-word; box-sizing: |
| 83 | border-box; text-align: left;”> |

| | |
|---|---|
| 84 | <p style=“margin-top: 0px; margin-bottom: 0px;”>Backlog</p> |

| | |
|---|---|
| 85 | </div> |

| | |
|---|---|
| 86 | </td> |

| | |
|---|---|
| 87 | </tr> |
| 88 | <tr style=“margin-top: 10px;”> |

| | |
|---|---|
| 89 | <td style=“padding: 0px; max-width: 150px; vertical-align: top;”> |

| | |
|---|---|
| 90 | <div style=“font-family: ‘Segoe UI’; font-size: 14px; line-height: |

| | |
|---|---|
| 91 | 18.62px; color: rgb(51, 51, 51); font-weight: 600; word-wrap: break-word; box-sizing: |
| 92 | border-box; text-align: left;”> |

| | |
|---|---|
| 93 | <p style=“margin-top: 0px; margin-bottom: 0px;”>Assigned to:</p> |

| | |
|---|---|
| 94 | </div> |

| | |
|---|---|
| 95 | </td> |
| 96 | <td style=“padding: 0px 0px 0px 10px; vertical-align: top;”> |

| | |
|---|---|
| 97 | <div style=“font-family: ‘Segoe UI’; font-size: 14px; line-height: |

| | |
|---|---|
| 98 | 18.62px; color: rgb(51, 51, 51); font-weight: 400; word-wrap: break-word; box-sizing: |
| 99 | border-box; text-align: left;”> |

| | |
|---|---|
| 100 | <p style=“margin-top: 0px; margin-bottom: 0px;”>David Claux</p> |

| | |
|---|---|
| 101 | </div> |

| | |
|---|---|
| 102 | </td> |

| | |
|---|---|
| 103 | </tr> |
| 104 | <tr style=“margin-top: 10px;”> |

| | |
|---|---|
| 105 | <td style=“padding: 0px; max-width: 150px; vertical-align: top;”> |

| | |
|---|---|
| 106 | <div style=“font-family: ‘Segoe UI’; font-size: 14px; line-height: |

| | |
|---|---|
| 107 | 18.62px; color: rgb(51, 51, 51); font-weight: 600; word-wrap: break-word; box-sizing: |
| 108 | border-box; text-align: left;”> |

| | |
|---|---|
| 109 | <p style=“margin-top: 0px; margin-bottom: 0px;”>Due date:</p> |

| | |
|---|---|
| 110 | </div> |

| | |
|---|---|
| 111 | </td> |
| 112 | <td style=“padding: 0px 0px 0px 10px; vertical-align: top;”> |

| | |
|---|---|
| 113 | <div style=“font-family: ‘Segoe UI’; font-size: 14px; line-height: |

| | |
|---|---|
| 114 | 18.62px; color: rgb(51, 51, 51); font-weight: 400; word-wrap: break-word; box-sizing: |
| 115 | border-box; text-align: left;”> |

| | |
|---|---|
| 116 | <p style=“margin-top: 0px; margin-bottom: 0px;”>Not set</p> |

| | |
|---|---|
| 117 | </div> |

| | |
|---|---|
| 118 | </td> |

| | |
|---|---|
| 119 | </tr> |

| | |
|---|---|
| 120 | </table> |

| | |
|---|---|
| 121 | </div> |
| 122 | <div style=“height: 20px;”></div> |
| 123 | <div> |

| | |
|---|---|
| 124 | <div style=“overflow: hidden;”> |

| | |
|---|---|
| 125 | <div style=“display: inline-table; width: 100%;”> |

| | |
|---|---|
| 126 | <div class=“ac-linkButton ” style=“overflow: hidden; white-space: nowrap; |

| | |
|---|---|
| 127 | text-overflow: ellipsis; flex: 0 1 100%;”>Set due date</div> |

| | |
|---|---|
| 128 | <div style=“height: 10px;”></div> |
| 129 | <div class=“ac-linkButton ” style=“overflow: hidden; white-space: nowrap; |

| | |
|---|---|
| 130 | text-overflow: ellipsis; flex: 0 1 100%;”>Comment</div> |

| | |
|---|---|
| 131 | <div style=“height: 10px;”></div> |
| 132 | <div class=“ac-linkButton ” style=“overflow: hidden; white-space: nowrap; |

| | |
|---|---|
| 133 | text-overflow: ellipsis; flex: 0 1 100%;”>View</div> |

| | |
|---|---|
| 134 | </div> |

| | |
|---|---|
| 135 | </div> |
| 136 | <div style=“background-color: rgba(234, 234, 234, 0.682353);”></div> |

| | |
|---|---|
| 137 | </div> |

| | |
|---|---|
| 138 | </div> |

By comparing the HTML shown in Table 3 to the payload shown in Table 1 and the host configuration resource shown in Table 2, the relationship between these data items can be discerned. For example, it can be seen that the payload specifies the actions “Set due date”, “Comment”, and “View” in lines 89-112, 113-141, and 142-146 of Table 1. These actions occur in the HTML in lines 126-127, 129-130, and 132-133 shown in Table 3. The formatting of these actions in the HTML is affected, for example, by the contents of the host configuration resource in line 3 of Table 2, which specifies that actions specified by the payload are to be oriented in a vertical direction; the structure of lines 125-134 in Table 3 reflects this vertical orientation, with its use of an inline-table made up of buttons and intervening vertical separators.

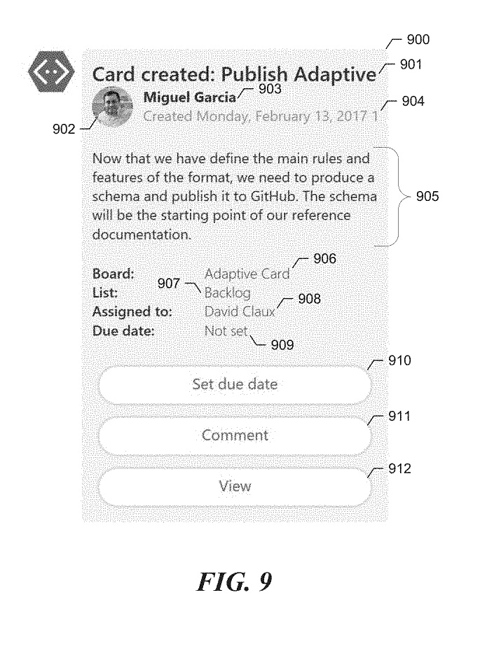

FIG. 9 is a display diagram showing how the content payload is rendered in the first scenario. The content 900 is rendered in a way suited to the first host application. In particular, its formatting characteristics are same as or similar to the formatting characteristics of native content in the first host application. The content includes a text element 901; an image element 902 in the first column, and text elements 903 and 904 in the second column; a text element 905; a fact set element 906-909; and action elements 910-912. The action elements are arranged vertically as specified by the host configuration resource for the first application.

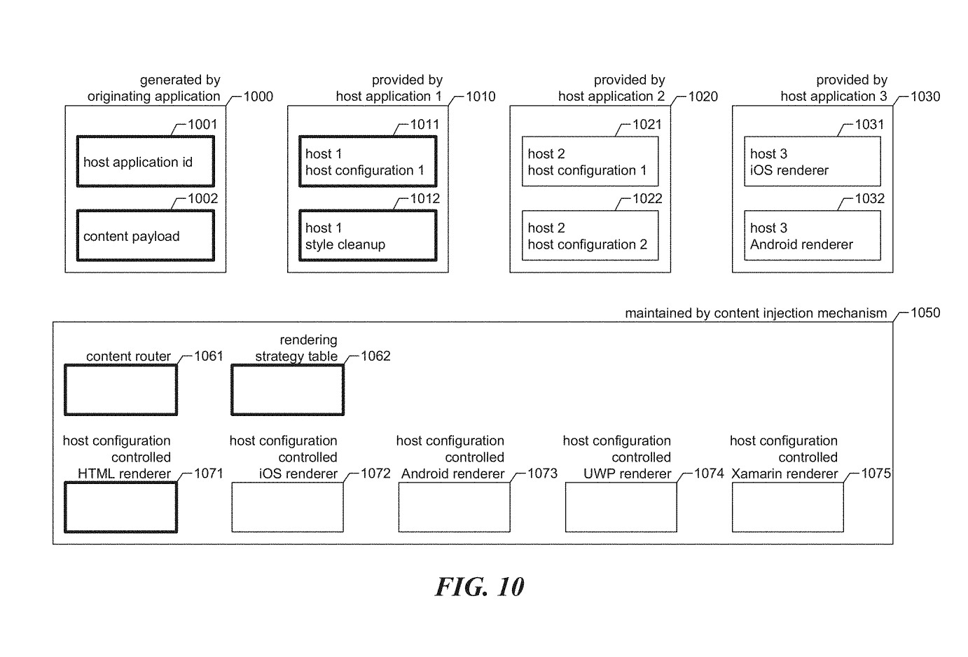

FIG. 10 is a state diagram showing a second rendering scenario. On the second scenario, the host application ID 1001 again identifies the first host application, which is executing on the HTML platform. In response, the facility selects the rendering strategy shown in row 702 of the rendering strategy table which specifies use of the shared renderer 1071 for the HTML platform together with the first host configuration resource 1011 for the first host application. The rendering strategy for this specifies that the rendered content produced is to be subjected to style cleanup resource 1012 for the first host application, which, unlike in scenario one, is given effect in scenario two.

Table 4 below shows the style cleanup resource for the first host application.

TABLE 4

| | |
|---|---|
| 1 | .ac-pushButton, .ac-linkButton { |

| | |
|---|---|
| 2 | box-shadow: 10px 10px 5px #888888; |

It can be seen that the style cleanup resource specifies a box-shadow attribute for the ac-pushButton and ac-linkButton styles used in the rendered HTML content shown in Table 3.

To cause the style cleanup resource to be applied to the rendered HTML content when the rendered HTML content is displayed by the first host application, the content router causes the lines shown in Table 5 below to be added to the rendered HTML content shown in Table 3 above.

TABLE 5

| | |
|---|---|
| 1 | <head> |

| | |
|---|---|
| 2 | <link rel=“stylesheet” type=“text/css” href=“skypeCard.css”> |

| | |
|---|---|
| 3 | </head> |

The string “skypeCard.css” in line 2 of Table 5 refers to and incorporates the host style cleanup resource shown in Table 4.

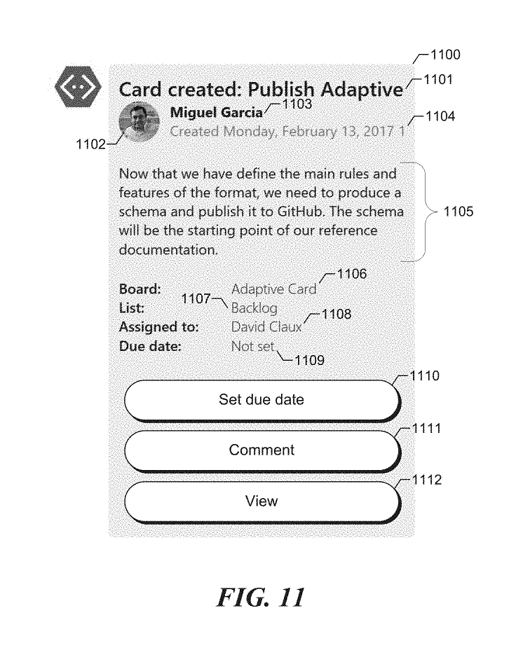

FIG. 11 is a display diagram showing how the content payload is rendered in the second scenario. By comparing buttons 1110-1112 shown in FIG. 11 to the corresponding buttons 910-912 shown in FIG. 9, it can be seen that the facility has added the box-shadow formatting attribute to these controls (adding additional shading on the bottom and right edges of these controls) in response to the contents of the host style cleanup resource shown in Table 4.

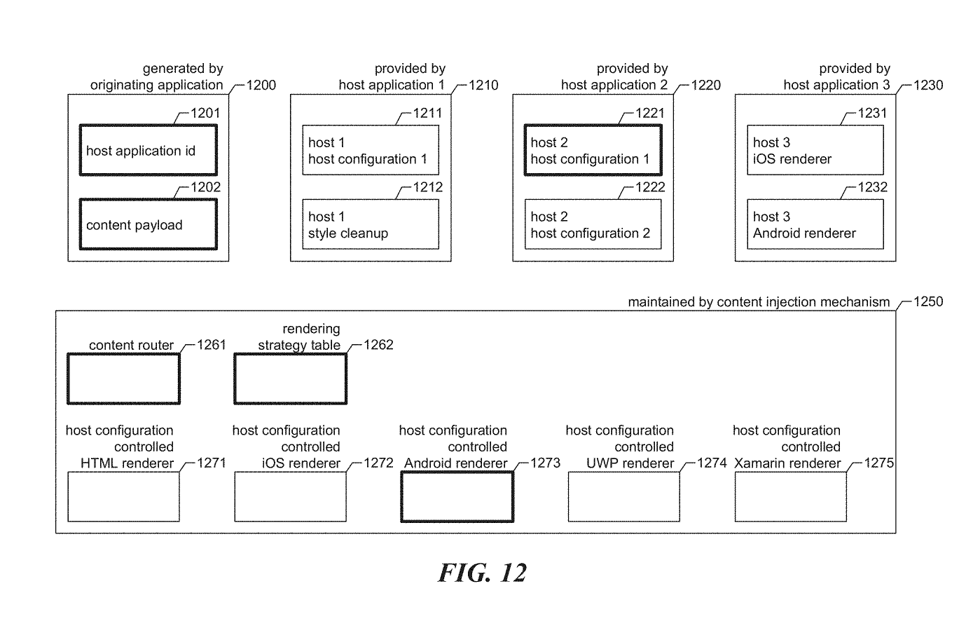

FIG. 12 is a state diagram showing a third rendering scenario. In the third scenario, the host application identifier 1201 identifies the second host application, in the Android platform. In response, the facility selects the rendering strategy shown in row 703, based on determining that both rendering strategy in row 703 and the rendering strategy shown in row 704 are eligible for application, and that the strategy identifier for row 703 is smaller than the strategy identifier for row 704, establishing it as the default among these two rendering strategies. In accordance with the rendering strategies shown in row 703, the facility invokes the shared renderer 1273 for the Android platform, using the first host configuration resource 1221 for the second host application.

Table 6 below shows the first host configuration resource for the second host application.

TABLE 6

| | |
|---|---|
| 1 | { |

| | |
|---|---|
| 2 | “supportsInteractivity”: true, |
| 3 | “strongSeparation”: { |

| | |
|---|---|
| 4 | “spacing”: 40, |
| 5 | “lineThickness”: 1, |
| 6 | “lineColor”: “#EEEEEE” |

| | |
|---|---|
| 7 | }, |
| 8 | “fontFamily”: “Segoe UI”, |
| 9 | “fontSizes”: { |

| | |
|---|---|
| 10 | “small”: 12, |
| 11 | “normal”: 14, |
| 12 | “medium”: 17, |
| 13 | “large”: 21, |
| 14 | “extraLarge”: 26 |

| | |
|---|---|
| 15 | }, |
| 16 | “fontWeights”: { |

| | |
|---|---|
| 17 | “lighter”: 200, |
| 18 | “normal”: 400, |
| 19 | “bolder”: 600 |

| | |
|---|---|
| 20 | }, |
| 21 | “colors”: { |

| | |
|---|---|
| 22 | “dark”: { |

| | |
|---|---|
| 23 | “normal”: “#333333”, |
| 24 | “subtle”: “#EE333333” |

| | |
|---|---|
| 25 | }, |
| 26 | “light”: { |

| | |
|---|---|
| 27 | “normal”: “#FFFFFF”, |
| 28 | “subtle”: “#88FFFFFF” |

| | |
|---|---|
| 29 | }, |
| 30 | “accent”: { |

| | |
|---|---|
| 31 | “normal”: “#2E89FC”, |
| 32 | “subtle”: “#882E89FC” |

| | |
|---|---|
| 33 | }, |
| 34 | “attention”: { |

| | |
|---|---|
| 35 | “normal”: “#FFD800”, |
| 36 | “subtle”: “#DDFFD800” |

| | |
|---|---|
| 37 | }, |
| 38 | “good”: { |

| | |
|---|---|
| 39 | “normal”: “#00FF00”, |
| 40 | “subtle”: “#DD00FF00” |

| | |
|---|---|
| 41 | }, |
| 42 | “warning”: { |

| | |
|---|---|
| 43 | “normal”: “#FF0000”, |
| 44 | “subtle”: “#DDFF0000” |

| | |
|---|---|
| 45 | } |

| | |
|---|---|
| 46 | }, |
| 47 | “imageSizes”: { |

| | |
|---|---|
| 48 | “small”: 40, |
| 49 | “medium”: 80, |
| 50 | “large”: 160 |

| | |
|---|---|
| 51 | }, |
| 52 | “actions”: { |

| | |
|---|---|
| 53 | “maxActions”: 5, |
| 54 | “separation”: { |

| | |
|---|---|
| 55 | “spacing”: 20 |

| | |
|---|---|
| 56 | }, |
| 57 | “buttonSpacing”: 20, |
| 58 | “stretch”: false, |
| 59 | “showCard”: { |

| | |
|---|---|
| 60 | “actionMode”: “InlineEdgeToEdge”, |
| 61 | “inlineCardSpacing”: 16, |
| 62 | “backgroundColor”: “#08000000”, |
| 63 | “padding”: { |

| | |
|---|---|
| 64 | “top”: 16, |
| 65 | “right”: 16, |
| 66 | “bottom”: 16, |
| 67 | “left”: 16 |

| | |
|---|---|
| 68 | } |

| | |
|---|---|
| 69 | }, |
| 70 | “actionsOrientation”: “Horizontal”, |
| 71 | “actionAlignment”: “Left” |

| | |
|---|---|
| 72 | }, |
| 73 | “adaptiveCard”: { |

| | |
|---|---|
| 74 | “backgroundColor”: “#FFFFFFFF”, |
| 75 | “padding”: { |

| | |
|---|---|
| 76 | “left”: 20, |
| 77 | “top”: 20, |
| 78 | “right”: 20, |
| 79 | “bottom”: 20 |

| | |
|---|---|
| 80 | } |

| | |
|---|---|
| 81 | }, |
| 82 | “container”: { |

| | |
|---|---|
| 83 | “separation”: { |

| | |
|---|---|
| 84 | “spacing”: 20 |

| | |
|---|---|
| 85 | }, |
| 86 | “normal”: { |
| 87 | }, |
| 88 | “emphasis”: { |

| | |
|---|---|
| 89 | “backgroundColor”: “#EEEEEE”, |
| 90 | “borderColor”: “#AAAAAA”, |
| 91 | “borderThickness”: { |

| | |
|---|---|
| 92 | “top”: 1, |
| 93 | “right”: 1, |
| 94 | “bottom”: 1, |
| 95 | “left”: 1 |

| | |
|---|---|
| 96 | }, |
| 97 | “padding”: { |

| | |
|---|---|
| 98 | “top”: 10, |
| 99 | “right”: 10, |
| 100 | “bottom”: 10, |
| 101 | “left”: 10 |

| | |
|---|---|
| 102 | } |

| | |
|---|---|
| 103 | } |

| | |
|---|---|
| 104 | }, |
| 105 | “textBlock”: { |

| | |
|---|---|
| 106 | “color”: “Dark”, |
| 107 | “separations”: { |

| | |
|---|---|
| 108 | “small”: { |

| | |
|---|---|
| 109 | “spacing”: 20 |

| | |
|---|---|
| 110 | }, |
| 111 | “normal”: { |

| | |
|---|---|
| 112 | “spacing”: 20 |

| | |
|---|---|
| 113 | }, |
| 114 | “medium”: { |

| | |
|---|---|
| 115 | “spacing”: 20 |

| | |
|---|---|
| 116 | }, |
| 117 | “large”: { |

| | |
|---|---|
| 118 | “spacing”: 20 |

| | |
|---|---|
| 119 | }, |
| 120 | “extraLarge”: { |

| | |
|---|---|
| 121 | “spacing”: 20 |

| | |
|---|---|
| 122 | } |

| | |
|---|---|
| 123 | } |

| | |
|---|---|
| 124 | }, |
| 125 | “image”: { |

| | |
|---|---|
| 126 | “size”: “Medium”, |
| 127 | “separation”: { |

| | |
|---|---|
| 128 | “spacing”: 20 |

| | |
|---|---|
| 129 | } |

| | |
|---|---|
| 130 | }, |
| 131 | “imageSet”: { |

| | |
|---|---|
| 132 | “imageSize”: “Medium”, |
| 133 | “separation”: { |

| | |
|---|---|
| 134 | “spacing”: 20 |

| | |
|---|---|
| 135 | } |

| | |
|---|---|
| 136 | }, |
| 137 | “factSet”: { |

| | |
|---|---|
| 138 | “separation”: { |

| | |
|---|---|
| 139 | “spacing”: 20 |

| | |
|---|---|
| 140 | }, |
| 141 | “title”: { |

| | |
|---|---|
| 142 | “color”: “Dark”, |
| 143 | “size”: “Normal”, |
| 144 | “isSubtle”: false, |
| 145 | “weight”: “Bolder” |

| | |
|---|---|
| 146 | }, |
| 147 | “value”: { |

| | |
|---|---|
| 148 | “color”: “Dark”, |
| 149 | “size”: “Normal”, |
| 150 | “isSubtle”: false, |
| 151 | “weight”: “Normal” |

| | |
|---|---|
| 152 | }, |
| 153 | “spacing”: 10 |

| | |
|---|---|
| 154 | }, |
| 155 | “input”: { |

| | |
|---|---|
| 156 | “separation”: { |

| | |
|---|---|
| 157 | “spacing”: 20 |

| | |
|---|---|
| 158 | } |

| | |
|---|---|
| 159 | }, |
| 160 | “columnSet”: { |

| | |
|---|---|
| 161 | “separation”: { |

| | |
|---|---|
| 162 | “spacing”: 20 |

| | |
|---|---|
| 163 | } |

| | |
|---|---|
| 164 | }, |
| 165 | “column”: { |

| | |
|---|---|
| 166 | “separation”: { |

| | |
|---|---|
| 167 | “spacing”: 20 |

| | |
|---|---|
| 168 | } |

| | |
|---|---|
| 169 | } |

| | |
|---|---|
| 170 | } |

When the facility invokes the standard Android renderer, passing it the first host configuration resource for the second host application, the standard Android renderer generates a rendered version of the payload shown in Table 1 above in a format suited for the Android platform. In order to facilitate comparison of this rendered version of the payload to the rendered version shown in Table 3 above of the payload, Table 7 below artificially shows the version the payload rendered for the second application using the first host configuration resource for the second application in HTML form.

TABLE 7

| | |
|---|---|
| 1 | <div id=“content” class=“markupRender”> |

| | |
|---|---|
| 2 | <div> |

| | |
|---|---|
| 3 | <div style=“border-width: 1px 1px 1px 3px; border-style: solid; border-color: |

| | |
|---|---|
| 4 | rgb(241, 241, 241) rgb(241, 241, 241) rgb(241, 241, 241) red;”> |

| | |
|---|---|
| 5 | <div class=“ac-container” style=“background-color: rgba(0, 0, 0, 0); padding: |

| | |
|---|---|
| 6 | 20px; box-sizing: border-box; width: 100%; text-align: left;”> |

| | |
|---|---|
| 7 | <div class=“ac-container” style=“padding: 0px; box-sizing: border-box; |

| | |
|---|---|
| 8 | width: 100%; text-align: left;”> |

| | |
|---|---|
| 9 | <div style=“font-family: &quot;Segoe UI&quot;; font-size: 17px; line- |

| | |
|---|---|
| 10 | height: 22.61px; color: rgb(51, 51, 51); font-weight: 600; white-space: nowrap; box- |
| 11 | sizing: border-box; width: 100%; text-align: left;”> |

| | |
|---|---|
| 12 | <p style=“margin-top: 0px; overflow: hidden; text-overflow: |

| | |
|---|---|
| 13 | ellipsis; margin-bottom: 0px;”>Card created: Publish Adaptive Card schema</p> |

| | |
|---|---|
| 14 | </div> |
| 15 | <div style=“height: 20px;”></div> |
| 16 | <div style=“overflow: hidden; box-sizing: border-box; width: 100%; |

| | |
|---|---|
| 17 | text-align: left;”> |

| | |
|---|---|
| 18 | <div style=“display: flex;”> |

| | |
|---|---|
| 19 | <div class=“ac-container” style=“padding: 0px; min-width: 0px; |

| | |
|---|---|
| 20 | flex: 0 1 auto;”> |

| | |
|---|---|
| 21 | <div class=“ac-image” style=“display: block; max-width: |

| | |
|---|---|
| 22 | 40px; box-sizing: border-box;”><img |
| 23 | src=“http://connectorsdemo.azurewebsites.net/images/MSC12_Oscar_002.jpg” style=“width: |
| 24 | 100%; border-radius: 50%; background-position: 50% 50%; background-repeat: no- |
| 25 | repeat;”></div> |

| | |
|---|---|
| 26 | </div> |
| 27 | <div style=“width: 20px; flex: 0 0 auto;”></div> |
| 28 | <div class=“ac-container” style=“padding: 0px; min-width: 0px; |

| | |
|---|---|
| 29 | flex: 1 1 auto;”> |

| | |
|---|---|
| 30 | <div style=“font-family: &quot;Segoe UI&quot;; font-size: |

| | |
|---|---|
| 31 | 14px; line-height: 18.62px; color: rgb(51, 51, 51); font-weight: 400; word-wrap: break- |
| 32 | word; box-sizing: border-box; width: 100%; text-align: left;”> |

| | |
|---|---|
| 33 | <p style=“margin-top: 0px; margin-bottom: |

| | |
|---|---|
| 34 | 0px;”><strong>Miguel Garcia</strong></p> |

| | |
|---|---|
| 35 | </div> |
| 36 | <div style=“font-family: &quot;Segoe UI&quot;; font-size: |

| | |
|---|---|
| 37 | 14px; line-height: 18.62px; color: rgba(51, 51, 51, 0.933333); font-weight: 400; word- |
| 38 | wrap: break-word; box-sizing: border-box; width: 100%; text-align: left;”> |

| | |
|---|---|
| 39 | <p style=“margin-top: 0px; margin-bottom: |

| | |
|---|---|
| 40 | 0px;”>Created Monday, February 13, 2017 10:08:39 PM</p> |

| | |
|---|---|
| 41 | </div> |

| | |
|---|---|
| 42 | </div> |

| | |
|---|---|
| 43 | </div> |

| | |
|---|---|
| 44 | </div> |

| | |
|---|---|
| 45 | </div> |
| 46 | <div style=“height: 20px;”></div> |
| 47 | <div class=“ac-container” style=“padding: 0px; box-sizing: border-box; |

| | |
|---|---|
| 48 | width: 100%; text-align: left;”> |

| | |
|---|---|
| 49 | <div style=“font-family: &quot;Segoe UI&quot;; font-size: 14px; line- |

| | |
|---|---|
| 50 | height: 18.62px; color: rgb(51, 51, 51); font-weight: 400; word-wrap: break-word; box- |
| 51 | sizing: border-box; width: 100%; text-align: left;”> |

| | |
|---|---|
| 52 | <p style=“margin-top: 0px; margin-bottom: 0px;”>Now that we have |

| | |
|---|---|
| 53 | define the main rules and features of the format, we need to produce a schema and |

| | |
|---|---|
| 54 | publish it to GitHub. The schema will be the starting point of |

| | |
|---|---|
| 55 | our reference documentation.</p> |

| | |
|---|---|
| 56 | </div> |
| 57 | <div style=“height: 20px;”></div> |
| 58 | <table style=“border-width: 0px; border-spacing: 0px; border-style: |

| | |
|---|---|
| 59 | none; border-collapse: collapse; display: block; overflow: hidden; box-sizing: border-box; |
| 60 | text-align: left;”> |

| | |
|---|---|
| 61 | <tr> |

| | |
|---|---|
| 62 | <td style=“padding: 0px; max-width: 150px; vertical-align: |

| | |
|---|---|
| 63 | top;”> |

| | |
|---|---|
| 64 | <div style=“font-family: &quot;Segoe UI&quot;; font-size: |

| | |
|---|---|
| 65 | 14px; line-height: 18.62px; color: rgb(51, 51, 51); font-weight: 600; word-wrap: break- |
| 66 | word; box-sizing: border-box; text-align: left;”> |

| | |
|---|---|
| 67 | <p style=“margin-top: 0px; margin-bottom: |

| | |
|---|---|
| 68 | 0px;”>Board:</p> |

| | |
|---|---|
| 69 | </div> |

| | |
|---|---|
| 70 | </td> |
| 71 | <td style=“padding: 0px 0px 0px 10px; vertical-align: top;”> |

| | |
|---|---|
| 72 | <div style=“font-family: &quot;Segoe UI&quot;; font-size: |

| | |
|---|---|
| 73 | 14px; line-height: 18.62px; color: rgb(51, 51, 51); font-weight: 400; word-wrap: break- |
| 74 | word; box-sizing: border-box; text-align: left;”> |

| | |
|---|---|
| 75 | <p style=“margin-top: 0px; margin-bottom: |

| | |
|---|---|
| 76 | 0px;”>Adaptive Card</p> |

| | |
|---|---|
| 77 | </div> |

| | |
|---|---|
| 78 | </td> |

| | |
|---|---|
| 79 | </tr> |
| 80 | <tr style=“margin-top: 10px;”> |

| | |
|---|---|
| 81 | <td style=“padding: 0px; max-width: 150px; vertical-align: |

| | |
|---|---|
| 82 | top;”> |

| | |
|---|---|
| 83 | <div style=“font-family: &quot;Segoe UI&quot;; font-size: |

| | |
|---|---|
| 84 | 14px; line-height: 18.62px; color: rgb(51, 51, 51); font-weight: 600; word-wrap: break- |
| 85 | word; box-sizing: border-box; text-align: left;”> |

| | |
|---|---|
| 86 | <p style=“margin-top: 0px; margin-bottom: |

| | |
|---|---|
| 87 | 0px;”>List:</p> |

| | |
|---|---|
| 88 | </div> |

| | |
|---|---|
| 89 | </td> |
| 90 | <td style=“padding: 0px 0px 0px 10px; vertical-align: top;”> |

| | |
|---|---|
| 91 | <div style=“font-family: &quot;Segoe UI&quot;; font-size: |

| | |
|---|---|
| 92 | 14px; line-height: 18.62px; color: rgb(51, 51, 51); font-weight: 400; word-wrap: break- |
| 93 | word; box-sizing: border-box; text-align: left;”> |

| | |
|---|---|
| 94 | <p style=“margin-top: 0px; margin-bottom: |

| | |
|---|---|
| 95 | 0px;”>Backlog</p> |

| | |
|---|---|
| 96 | </div> |

| | |
|---|---|
| 97 | </td> |

| | |
|---|---|
| 98 | </tr> |
| 99 | <tr style=“margin-top: 10px;”> |

| | |
|---|---|
| 100 | <td style=“padding: 0px; max-width: 150px; vertical-align: |

| | |
|---|---|
| 101 | top;”> |

| | |
|---|---|
| 102 | <div style=“font-family: &quot;Segoe UI&quot;; font-size: |

| | |
|---|---|
| 103 | 14px; line-height: 18.62px; color: rgb(51, 51, 51); font-weight: 600; word-wrap: break- |
| 104 | word; box-sizing: border-box; text-align: left;”> |

| | |
|---|---|
| 105 | <p style=“margin-top: 0px; margin-bottom: |

| | |
|---|---|
| 106 | 0px;”>Assigned to:</p> |

| | |
|---|---|
| 107 | </div> |

| | |
|---|---|
| 108 | </td> |
| 109 | <td style=“padding: 0px 0px 0px 10px; vertical-align: top;”> |

| | |
|---|---|
| 110 | <div style=“font-family: &quot;Segoe UI&quot;; font-size: |

| | |
|---|---|
| 111 | 14px; line-height: 18.62px; color: rgb(51, 51, 51); font-weight: 400; word-wrap: break- |
| 112 | word; box-sizing: border-box; text-align: left;”> |

| | |
|---|---|
| 113 | <p style=“margin-top: 0px; margin-bottom: 0px;”>David |

| | |
|---|---|
| 114 | Claux</p> |

| | |
|---|---|
| 115 | </div> |

| | |
|---|---|
| 116 | </td> |

| | |
|---|---|
| 117 | </tr> |
| 118 | <tr style=“margin-top: 10px;”> |

| | |
|---|---|
| 119 | <td style=“padding: 0px; max-width: 150px; vertical-align: |

| | |
|---|---|
| 120 | top;”> |

| | |
|---|---|
| 121 | <div style=“font-family: &quot;Segoe UI&quot;; font-size: |

| | |
|---|---|
| 122 | 14px; line-height: 18.62px; color: rgb(51, 51, 51); font-weight: 600; word-wrap: break- |
| 123 | word; box-sizing: border-box; text-align: left;”> |

| | |
|---|---|
| 124 | <p style=“margin-top: 0px; margin-bottom: 0px;”>Due |

| | |
|---|---|
| 125 | date:</p> |

| | |
|---|---|
| 126 | </div> |

| | |
|---|---|
| 127 | </td> |
| 128 | <td style=“padding: 0px 0px 0px 10px; vertical-align: top;”> |

| | |
|---|---|
| 129 | <div style=“font-family: &quot;Segoe UI&quot;; font-size: |

| | |
|---|---|
| 130 | 14px; line-height: 18.62px; color: rgb(51, 51, 51); font-weight: 400; word-wrap: break- |
| 131 | word; box-sizing: border-box; text-align: left;”> |

| | |
|---|---|
| 132 | <p style=“margin-top: 0px; margin-bottom: 0px;”>Not |

| | |
|---|---|
| 133 | set</p> |

| | |
|---|---|
| 134 | </div> |

| | |
|---|---|
| 135 | </td> |

| | |
|---|---|
| 136 | </tr> |

| | |
|---|---|
| 137 | </table> |

| | |
|---|---|
| 138 | </div> |
| 139 | <div style=“height: 20px;”></div> |
| 140 | <div> |

| | |
|---|---|
| 141 | <div style=“overflow: hidden;”> |

| | |
|---|---|
| 142 | <div style=“display: inline-flex;”> |

| | |
|---|---|
| 143 | <div class=“ac-linkButton ” style=“overflow: hidden; white- |

| | |
|---|---|
| 144 | space: nowrap; text-overflow: ellipsis; flex: 0 1 auto;”>Set due date</div> |

| | |
|---|---|
| 145 | <div style=“flex: 0 0 auto; width: 20px;”></div> |
| 146 | <div class=“ac-linkButton ” style=“overflow: hidden; white- |

| | |
|---|---|
| 147 | space: nowrap; text-overflow: ellipsis; flex: 0 1 auto;”>Comment</div> |

| | |
|---|---|
| 148 | <div style=“flex: 0 0 auto; width: 20px;”></div> |
| 149 | <div class=“ac-linkButton ” style=“overflow: hidden; white- |

| | |
|---|---|
| 150 | space: nowrap; text-overflow: ellipsis; flex: 0 1 auto;”>View</div> |

| | |
|---|---|
| 151 | </div> |

| | |
|---|---|
| 152 | </div> |
| 153 | <div style=“background-color: rgba(0, 0, 0, 0.0313726);”></div> |

| | |
|---|---|
| 154 | </div> |

| | |
|---|---|
| 155 | </div> |

| | |
|---|---|
| 156 | </div> |
| 157 | <div style=“height: 20px;”></div> |
| 158 | <div><button class=“button”>Speak this card</button> |

| | |
|---|---|
| 159 | <audio id=“player” autoplay=“”></audio> |

| | |
|---|---|
| 160 | </div> |

| | |
|---|---|
| 161 | </div> |

| | |
|---|---|
| 162 | </div> |

By comparing Table 7 to Tables 2, 3, and 6, one can discern that the version of the payload rendered for the second application shown in Table 7 differs from the version of the payload rendered for the first application shown in Table 3 in ways that result from differences between the first host configuration resource for the first host application shown in Table 2 and the first host configuration resource for the second host application shown in Table 6. For example, one way that Table 6 differs from Table 2 is that line 70 of Table 6 specifies an actionOrientation of “Horizontal”, in contrast to the actionOrientation of “Vertical” specified in line 2 of Table 2. This has the effect of, in lines 144-151 of Table 7, arranging horizontally the actions arranged vertically for the first application as specified in lines 125-134 of Table 3. Those of skill in the art will identify numerous other differences between the rendered versions of the payloads shown in Tables 3 and 7 springing from differences between the host configuration resources shown in Tables 2 and 6, including, for example, fonts, font sizes, and color values

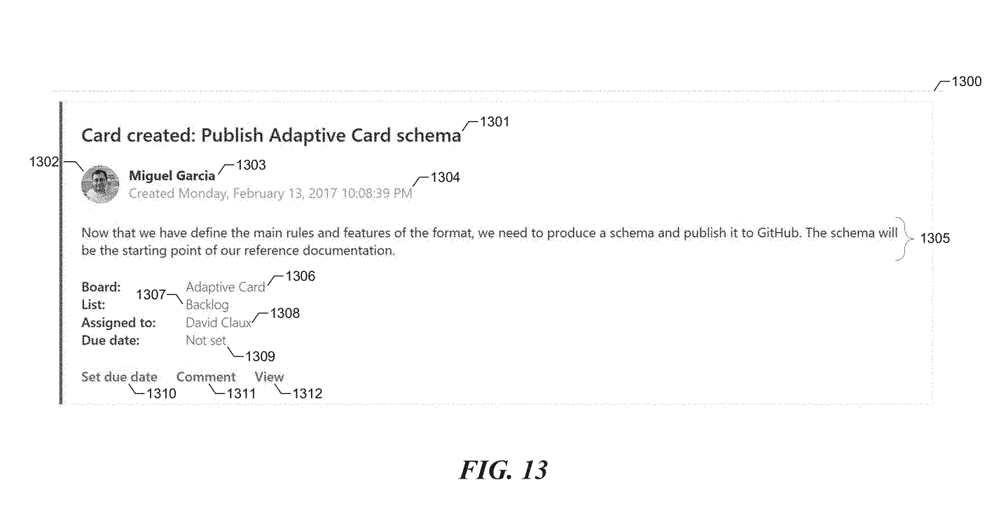

FIG. 13 is a display diagram showing the content rendered in scenario three for the second host application. It can be seen that this content 1300, rendered for inclusion in the second host application, contains the same information 1301-1312 in a markedly different appearance than the rendered content shown in FIG. 9, which was rendered to suit the visual style of the first host application. As one example, the three actions 1310-1312 are arranged horizontally, as contrasted with the corresponding actions 910-912 arranged vertically for the first application.

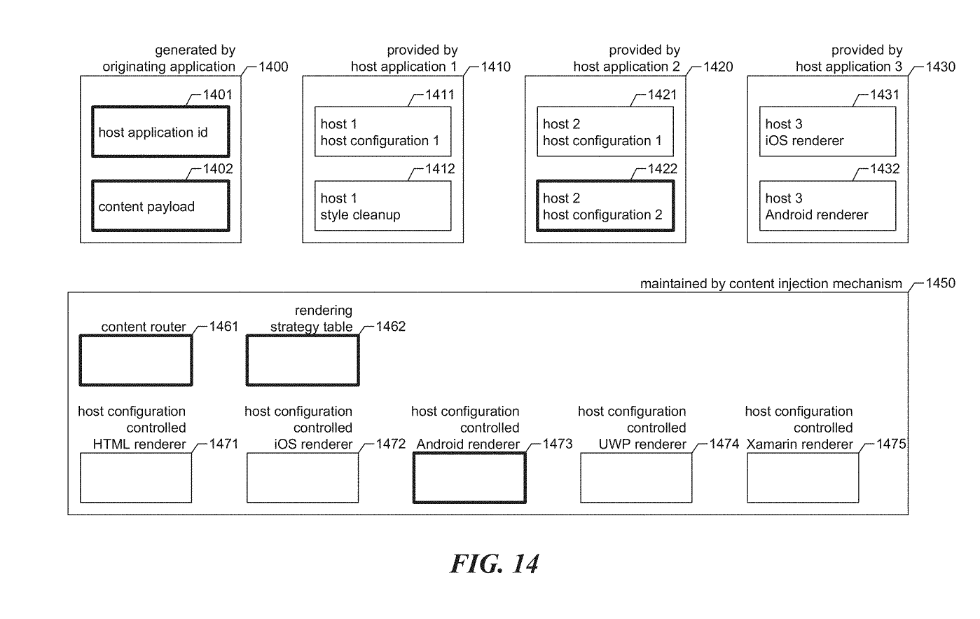

FIG. 14 is a state diagram showing a fourth rendering scenario. The fourth rendering scenario is the same as the third rendering scenario discussed above in connection with FIG. 11, except that the originating application elects the rendering strategy shown in row 704 by explicitly specifying the strategy identifier “2” in connection with the content payload. In response, the facility again invokes the shared renderer 1473 for the Android platform, this time together with the second host configuration resource 1422 for the second host application, producing a different version of the content payload rendered for the second application.

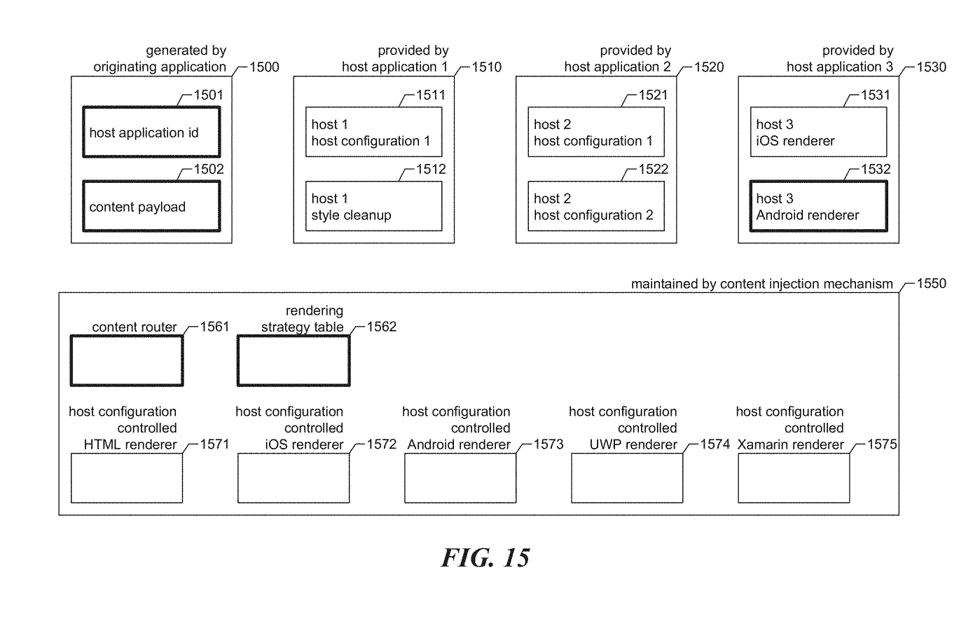

FIG. 15 is a state diagram showing a fifth rendering scenario. In the fifth scenario, the originating application identifies the third host application, executing in the Android platform. On this basis, the facility selects the rendering strategy shown in row 706, which specifies the use of the custom Android renderer 1532 for the third host application. Accordingly, the facility invokes this custom renderer to render the contact for presentation in the context of the third host application.

In some examples, the facility permits the originating application to include in the payload conditional logic. The conditional logic has the effect of either including or excluding content or content relationship elements on the basis of whether condition specified by the conditional logic are satisfied. In some examples, the conditions in the conditional logic are evaluated at display time. In some examples, the conditions in the conditional logic are evaluated at rendering time. Table 8 below shows conditional logic that is added to the content payload shown in Table 1 in a sixth rendering scenario.

TABLE 8

| | |
|---|---|
| 1 | { |

| | |
|---|---|
| 2 | “type”: “Action.Submit”, |
| 3 | “title”: “Approve”, |
| 4 | “onClick”: “function( ) { parent.actions[1].title = |
| | ‘Approved’; |

| | |
|---|---|
| 5 | parent.actions[1].disabled; }” |

| | |
|---|---|
| 6 | } |

In particular, these lines establish an “Approve” action that, when clicked, changes its title to “Approved” and becomes disabled. Whether the action has been clicked is the condition that is evaluated by the conditional logic.

In some examples, the facility allows the originating application to include in a payload information about the expiration of some or all of the content in the payload. In some such examples, this includes an expiration date and time after which the content in the payload is to be considered expired, as well as a reference that can be used to retrieve an updated version of the payload after expiration. Table 9 below shows sample expiration information that's included in the payload shown in Table 1 in a seventh rendering scenario.

TABLE 9

| | |
|---|---|
| 1 | “expires”:“2017-05-01 13:05:10”, |
| 2 | “refreshUrl”:”http://contosor.cosn/card/12345” |

Line 1 of Table 9 specifies the expiration time of the payload contents, and line 2 specifies the reference that can be used to retrieve an updated, or “refreshed” version.

In some examples, the facility provides a method in a computing system for injecting content into host applications, comprising: in a content injection mechanism: receiving from an originating program a content payload compliant with a content payload schema, the content payload specifying (1) two or more elements of content, and (2) a relative significance among at least two of the elements of content; receiving from the originating program information identifying a host program in the context of which the content of the received content payload is to be rendered; determining a rendering strategy based at least in part on the identity of the host program; using the determined rendering strategy to generate a rendered version of the content of the received content payload; and causing the generated rendered version of the content of the received content payload to be displayed in the context of the identified host program.

In some examples, the facility provides one or more instances of computer-readable media, collectively having contents configured to cause a computing system to perform a method for registering a distinguished host application with a content injection mechanism, the method comprising: on behalf of the distinguished host application, receiving information identifying a first host configuration resource to be used by a renderer program shared across applications to render content injection payloads for presentation in the context of the distinguished host application; and persistently storing an indication of the identified first host configuration resource in connection with the identity of the distinguished host application for access when a content injection payload is received for the distinguished host application.

In some examples, the facility provides a cross-application content injection system, comprising: a processor; and one or more memories, the memories collectively having contents that, when executed by the processor, cause the performance of a method, the method comprising: receiving from an originating application a content payload, the content payload specifying (1) two or more elements of content, and (2) a relative significance among at least two of the elements of content; determining a first rendering strategy; using the determined first rendering strategy to generate a first rendered version of the content of the received content payload; causing the generated rendered first version of the content of the received content payload to be displayed in the context of a host application; determining a second rendering strategy; using the determined second rendering strategy to generate a second rendered version of the content of the received content payload, the second rendered version of the content of the received content payload being different from the first rendered version of the content of the received content payload; and causing the generated rendered second version of the content of the received content payload to be displayed in the context of a host application.

In some examples, the facility provides one or more memories collectively storing a rendering strategy data structure, the data structure comprising: a plurality of entries, each entry comprising: information identifying a host application program; and information specifying a rendering strategy to be used to render content injection payloads for presentation in the context of the identified host application program,

such that, when a content injection payload is received from an originating program in the context of a specified host application program, the contents of the data structure are usable to determine rendering strategy for the received content injection payload.

It will be appreciated by those skilled in the art that the above-described facility may be straightforwardly adapted or extended in various ways. While the foregoing description makes reference to particular examples, the scope of the invention is defined solely by the claims that follow and the elements recited therein.

We claim:

1. A method in a computing system for injecting content into host applications, comprising:
in a content injection mechanism:
receiving from an originating program a content payload compliant with a content payload schema, the content payload specifying (1) two or more elements of content, and (2) a relative significance among at least two of the elements of content;
receiving from the originating program information identifying a host program in the context of which the content of the received content payload is to be rendered;
determining a rendering strategy based at least in part on the identity of the host program;
using the determined rendering strategy to generate a rendered version of the content of the received content payload; and
causing the generated rendered version of the content of the received content payload to be displayed in the context of the identified host program.

2. The method of claim 1 wherein at least one of the specified elements of content is a text string, an image, an action, or user input to be obtained in connection with the display of the rendered version of the content of the received content payload.

3. The method of claim 1 wherein the content payload further specifies a condition that must be met to include at least one of the specified elements when generating a rendered version of the content of the received content payload.

4. The method of claim 1 wherein the content payload further specifies (1) a time after the receipt of the content payload when one or more of the elements specified by the content payload will no longer be up-to-date, and (2) a reference usable to retrieve an updated version of some or all of the elements specified by the content payload at a time after the specified time.

5. The method of claim 1 wherein the determined rendering strategy specifies the use of a renderer program used both by the identified host program and one or more host programs other than the identified host program.

6. The method of claim 5 wherein the determined rendering strategy further specifies the use of a host configuration resource defining one or more styles applied by the specified rendering program in generating the rendered version of the content of the received content payload.

7. The method of claim 6, further comprising:
after execution of the specified renderer program, executing a style cleanup program specialized to the identified host program to modify the rendered version of the content of the received content payload

8. The method of claim 1, further comprising:
in the content injection mechanism:
determining a platform on which a rendered version of the content of the received content payload to be displayed in the context of the host program is to be displayed,
and wherein determining a rendering strategy is performed at least in part on the determined platform.

9. The method of claim 1 wherein the rendering strategy is determined at least in part based upon information provided by the identified host program during registration with the content injection mechanism by the identified host program.

10. The method of claim 1 wherein the rendering strategy is determined at least in part based upon information provided by the identified host program at a time after the content payload is received by the content injection mechanism.

11. The method of claim 1 wherein the determined rendering strategy specifies the use of a renderer program specialized to the identified host program.

12. The method of claim 1 wherein the rendering strategy is determined at least in part based upon information stored in a rendering strategy table representing information provided by a plurality of host programs including the identified host program as part of registration of the plurality of host programs with the content injection mechanism.

13. The method of claim 1 wherein the rendering strategy is determined at least in part based upon a rendering strategy election submitted by the originating program.

14. One or more instances of computer-readable media, collectively having contents configured to cause a computing system to perform a method for registering a distinguished host application with a content injection mechanism, the method comprising:
on behalf of the distinguished host application, receiving information identifying a first host configuration resource to be used by a renderer program shared across applications to render content injection payloads for presentation in the context of the distinguished host application; and
persistently storing an indication of the identified first host configuration resource in connection with the identity of the distinguished host application for access when a content injection payload is received for the distinguished host application.

15. The instances of computer-readable media of claim 14, the method further comprising:
on behalf of the distinguished host application, receiving information identifying a second host configuration resource to be used by a renderer program shared across applications to render content injection payloads for presentation in the context of the distinguished host application, the second host configuration resource being different from the first host configuration resource; and
persistently storing an indication of the identified second host configuration resource in connection with the identity of the distinguished host application for access when a content injection payload is received for the distinguished host application.

16. The instances of computer-readable media of claim 14, the method further comprising:
on behalf of the distinguished host application, receiving information identifying a style cleanup resource to be applied to versions of content injection payloads rendered for the distinguished host application by the renderer program shared across applications to for presentation in the context of the distinguished host application; and
persistently storing an indication of the identified style cleanup resource in connection with the identity of the distinguished host application for access when rendered version of a content injection payload is rendered for the distinguished host application.

17. The instances of computer-readable media of claim 14, the method further comprising:
on behalf of a second host application different from the distinguished host application, receiving information identifying a renderer program specialized to the second host application to be used to render content injection payloads for presentation in the context of the second host application; and
persistently storing an indication of the identified specialized renderer program in connection with the identity of the second host application for access when a content injection payload is received for the second host application.

18. The instances of computer-readable media of claim 14, the method further comprising:
receiving from an originating application a content injection payload designated for rendering in the context of the distinguished host application;
based at least in part on receiving the content injection payload, accessing the stored indication of the first host configuration resource;
invoking the shared renderer program upon the received content injection payload, providing the indicated first host configuration resource available to the shared renderer program as part of the invocation to obtain a rendered version of the received content injection payload; and
causing the obtained rendered version of the received content injection payload to be presented in the context of the distinguished host application.

19. A cross-application content injection system, comprising:
a processor; and
one or more memories, the memories collectively having contents that, when executed by the processor, cause the performance of a method, the method comprising:
receiving from an originating application a content payload, the content payload specifying (1) two or more elements of content, and (2) a relative significance among at least two of the elements of content;
determining a first rendering strategy;
using the determined first rendering strategy to generate a first rendered version of the content of the received content payload;
causing the generated rendered first version of the content of the received content payload to be displayed in the context of a host application;
determining a second rendering strategy;
using the determined second rendering strategy to generate a second rendered version of the content of the received content payload, the second rendered version of the content of the received content payload being different from the first rendered version of the content of the received content payload; and
causing the generated rendered second version of the content of the received content payload to be displayed in the context of a host application.

20. The cross-application content injection system of claim 19 wherein:
the first rendering strategy is determined for a first host application in the context of which the content of the received content payload is to be presented, and the second rendering strategy is determined for a second host application in the context of which the content of the received content payload is to be presented, and the generated rendered first version of the content of the received content payload is displayed in the context of the first host application, and the generated rendered second version of the content of the received content payload is displayed in the context of the second host application,
or the first rendering strategy is determined for a first host application platform on which the content of the received content payload is to be presented, and the second rendering strategy is determined for a second host application platform on which the content of the received content payload is to be presented, and the generated rendered first version of the content of the received content payload is displayed on the first host application platform, and the generated rendered second version of the content of the received content payload is displayed on the second host application platform,
or the first rendering strategy is determined based on a first rendering strategy election made by the originating application, and the second rendering strategy is determined based on a second rendering strategy election made by the originating application.
